(19) United States
(12) Patent Application Publication
(10) Pub. No.: US 2015/0106278 A1
(43) Pub. Date: Apr. 16, 2015

(54) METHOD AND APPARATUS FOR SEARCH AND ANALYSIS OF REAL ESTATE DATA

(71) Applicant: CoStar Realty Information, Inc., Washington, DC (US)

(72) Inventors: Andrew Florance, Washington, DC (US); Jeffrey Wells, Washington, DC (US); Jay Spivey, Washington, DC (US); Scott Bohl, Washington, DC (US); Yuri Anderson, Washington, DC (US); Curtis Ricketts, Washington, DC (US); Joseph Klug, Washington, DC (US)

(21) Appl. No.: 14/514,325

(22) Filed: Oct. 14, 2014

Related U.S. Application Data
(60) Provisional application No. 61/889,870, filed on Oct. 11, 2013.

(51) Int. Cl. G06Q 50/16; G06F 17/30; G06F 3/0484; G06Q 10/06

(52) U.S. Cl. CPC G06Q 50/16; G06Q 10/067; G06F 17/30528; G06F 3/0484
USPC 705/313; 707/722

(57) ABSTRACT

A method and system for dynamically updating search parameters for a real estate database, the real estate database including records corresponding to real estate properties, the method including transmitting a user interface including a plurality of indicators corresponding to a plurality of real estate uses and one or more search parameters, receiving a selection of a real estate use in the plurality of real estate uses through the selection of an indicator in the plurality of indicators, determining one or more use-specific search parameters corresponding to the selected real estate use, the one or more use-specific search parameters being determined by querying a data structure storing a mapping of the plurality of real estate uses to a plurality of use-specific search parameters, and updating the user interface to include the one or more use-specific search parameters in addition to the one or more search parameters.

### RELATED APPLICATION DATA

This application claims priority to U.S. Provisional Application No. 61/889,870, filed Oct. 11, 2013, the disclosure of which is hereby incorporated by reference in its entirety.

### COPYRIGHT NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### BACKGROUND

When considering a purchase or lease of real estate, especially commercial real estate, a potential buyer or lessee has to consider a myriad of attributes of the property. Also, comparison between various alternative properties is difficult. One tool that has been used to simplify the process is the concept of “comparables” or “comps,” i.e., other properties that have similar attributes that can be used for comparison. While the use of comps is often helpful, it is difficult to determine a group of comparable properties because each consumer may have different needs and thus different attributes that need be considered to determine comparable properties. For example, one consumer may want properties that are near a main street, have storefront access and 10,000 square feet of available space while another consumer may need to be in a specific neighborhood and need 50,000 square feet.

In addition to the common attributes, such as the location and size of the building and the available space, a consumer must consider zoning, tenants, price, building appearance, vacancy rates, available transportation, building age, amenities, various financial attributes, and many other factors to make the best decision. The decision is so complex that professional brokers and other intermediary models have arisen to assist the consumer. In fact, virtually all commercial real estate transactions involve at least one intermediary.

Recently, databases have emerged that provide access to real estate information, and commercial real estate information in particular. For example, the CoStar® database can be searched by various attribute filters to provide listings of properties satisfying the filter attributes. Such databases often include a great deal of textual information about properties and images of the properties and related maps. Brokers and other intermediaries use such databases to discover properties and help clients make decisions thereon.

Real estate, by nature, is suitable for one or more uses. The significant attributes for use of, a retail store, for example, are very different from the significant attributes of another use, a factory for example. A single property could be suitable for multiple uses. However, the searchable attributes for the uses might be quite different. Accordingly, it is difficult to search for real properties without requiring the user to understand and provide a myriad of variables for use in a search query. Further, data entry can be cumbersome when there are so many significant parameters to be searched. Finally, it can be difficult to financially model various real estate options in order to make a sound business decision.

### BRIEF DESCRIPTION OF THE DRAWINGS

FIG. 1 is a flowchart illustrating a method for dynamically updating search parameters for a real estate database according to an exemplary embodiment.

FIG. 2 shows a user interface for searching the real estate database according to an exemplary embodiment.

FIGS. 3A-3F show dynamic search parameter interfaces for searching the real estate database according to an exemplary embodiment.

FIGS. 4A-4C show expanded search criteria interfaces for searching the real estate database according to an exemplary embodiment.

FIG. 5 illustrates real estate use to search parameter mapping table according to an exemplary embodiment.

FIG. 6 is a flowchart illustrating a method for removing search results from a search of a real estate database according to an exemplary embodiment.

FIG. 7 shows a user interface for removing search results from a search of a real estate database according to an exemplary embodiment.

FIG. 8 is a flowchart illustrating a method for generating a financial model relating to real estate properties according to an exemplary embodiment.

FIG. 9 shows a user interface for entering a data value and selecting unit of measurement in a single data field according to an exemplary embodiment.

FIG. 10 is a flowchart illustrating a method for transmitting multi-dimensional data relating to real estate properties according to an exemplary embodiment.

FIG. 11 is a flowchart illustrating a method for updating an interface with three dimensional data according to an exemplary embodiment.

FIG. 12 is another flowchart illustrating a method for updating an interface with three dimensional data according to an exemplary embodiment.

FIG. 13 shows a user interface for transmitting multi-dimensional data relating to real estate properties according to an exemplary embodiment.

FIG. 14 is a flowchart illustrating a method for providing customized analytics based on search results from a real estate database.

FIG. 15 is another flowchart illustrating a method for providing customized analytics based on search results from a real estate database.

FIGS. 16-17 illustrate customized analytics relating to real estate properties according to an exemplary embodiment.

FIG. 18 is a flowchart illustrating a method for aggregating search results by tenant according to an exemplary embodiment.

FIG. 19 illustrates a tenant association data structure according to an exemplary embodiment.

FIG. 20 is a flowchart illustrating a method for grouping record based on tenant identifications according to an exemplary embodiment.

FIG. 21 illustrates aggregated tenant result data by square feet according to an exemplary embodiment.

FIG. 22 is a flowchart illustrating a method for transmitting tenant result data according to an exemplary embodiment.

FIG. 23 illustrates aggregated tenant result data categorized by square foot size range according to an exemplary embodiment.

FIG. 24A is another flowchart illustrating a method for transmitting tenant result data according to an exemplary embodiment.

FIG. 24B illustrates aggregated tenant result data across industries according to an exemplary embodiment.

FIG. 25A is a flowchart illustrating a method for grouping record based on tenant characteristics according to an exemplary embodiment.

FIG. 25B illustrates aggregated group result data across lease expiration years according to an exemplary embodiment.

FIG. 26 is a flowchart illustrating a method for estimating a probability of leasing a real estate property according to an exemplary embodiment.

FIG. 27 illustrates a graph of probabilities of leasing a real estate property at different time frames according to an exemplary embodiment.

FIG. 28 illustrates an exemplary computing environment that can be used to carry out the methods disclosed herein according to an exemplary embodiment.

### DETAILED DESCRIPTION

While methods, apparatuses, and computer-readable media are described herein by way of examples and embodiments, those skilled in the art recognize that the methods, apparatuses, and computer-readable media are not limited to the embodiments or drawings described. It should be understood that the drawings and description are not intended to be limited to the particular form disclosed. Rather, the intention is to cover all modifications, equivalents and alternatives falling within the spirit and scope of the disclosure. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

The Applicant has discovered methods and systems for improved search and analysis of real estate data. The methods and systems include a method and system for dynamically updating search parameters for a real estate database, a method and system for removing search results from a search of a real estate database, a method and system for generating a financial model relating to real estate properties, a method and system for transmitting three-dimensional data corresponding to real estate properties, a system and method for providing customized analytics based on search results from a real estate database, a system and method for aggregating search results by tenant, and a system and method for estimating a probability of leasing a real estate property.

Dynamic Search Parameters

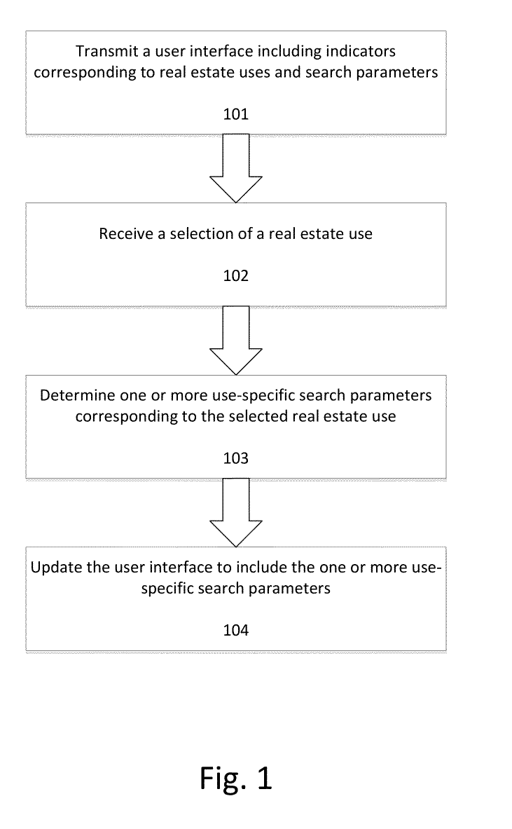

FIG. 1 is flowchart illustrating a method for dynamically updating search parameters for a real estate database. The real estate database can include records corresponding to different real estate properties. At step 101 a user interface including a plurality of indicators corresponding to a plurality of real estate uses and one or more search parameters is transmitted to a user.

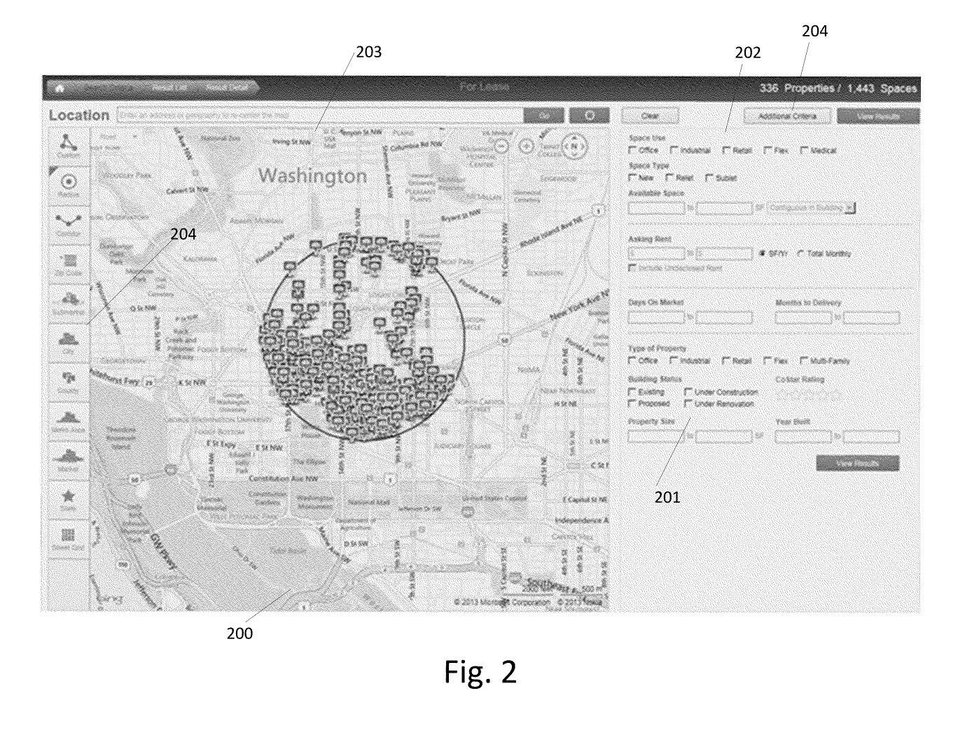

FIG. 2 illustrates an example of a user interface 200 that can be transmitted. As shown in the figure, the interface 200 includes a plurality of indicators 202 corresponding to a plurality of real estate uses. These can include office, industrial, retail, flex, medical, or any other particular real estate uses. The interface also includes one or more search parameters, such as search parameters 201 which relate to characteristics of particular real estate properties and additional search parameters 204 which relate to location characteristics. A search query can based in part on a radius from a selected location, a specified address, or a designation of a city or county provided in the interface 200. Search parameter fields can include, among others, an Available Space field, a Space Type field, an Asking Rent field, a Building Status field and a Property Size field. The interface 200 can include a map 203 including a graphical display of any results which meet the search parameters and other criteria specified by the user. Results can be presented as icons or other indicators on the map 203. The interface 200 also includes an option to select additional criteria 204 for conducting a search. The additional criteria 204 indicator can be selected to allow a user to enter additional more detailed criteria relating to their search. As shown in the interface 200 of FIG. 2, a real estate use has not been selected.

As shown in FIG. 1, at step 102 a selection of a real estate use in the plurality of real estate uses is received through the selection of an indicator in the plurality of indicators. For example a user can select any one of the real-estate use indicators 202 in interface 200 of FIG. 2. Additionally, a user can select more than one real estate use indicator.

At step 103 one or more use-specific search parameters corresponding to the selected real estate use are determined. The one or more use-specific search parameters can be determined by querying a data structure storing a mapping of the plurality of real estate uses to a plurality of use-specific search parameters. For example, an index or table can store one or more use-specific search parameters that correspond to each real estate use. After a user selects a real estate use, the index or table can be queried to identify and retrieve the one or more use-specific search parameters that correspond to the selected real estate use. If the user has selected more than one real estate use indicator, than multiple sets of use-specific search parameters can be determined based on the selected real estate use indicators.

At step 104 the user interface is updated to include the one or more use-specific search parameters in addition to the one or more search parameters. The updating can be performed in a variety of ways. For example, the user interface can be updated by revising a layout of the user interface to include the one or more use-specific search parameters. This can include modifying the code corresponding to the user interface to insert the one or more user-specific search parameters at a particular position in the user interface. The locations of the use-specific search parameters can be customized and/or determined based on a template associated with the use-specific search parameters.

Additionally, the user interface can be updated by transmitting a new user interface corresponding to the selected real estate use(s). For example, a use-specific user interface corresponding to the selected real estate use can be identified and the use-specific user interface can then be transmitted in place of the user interface.

After the user interface is updated, parameter values for at least one of the one or more search parameters or the one or more use-specific search parameters can be received and one or more records in the real estate database can be retrieved based on the received parameter values. The records can be transmitted to the user via the user interface.

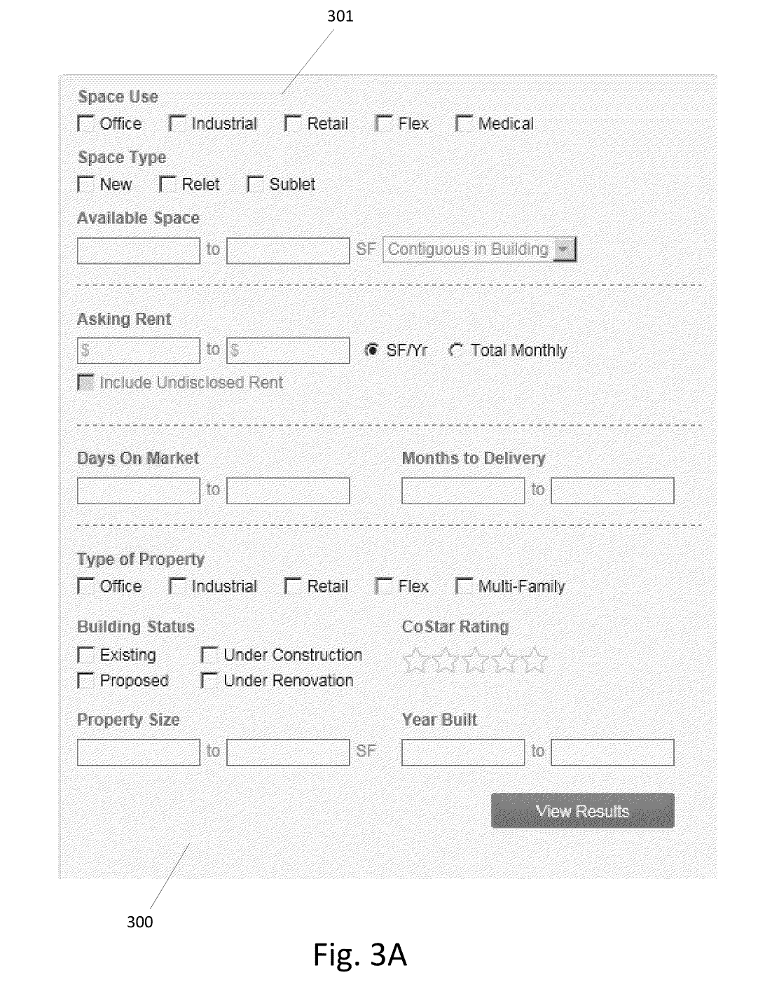

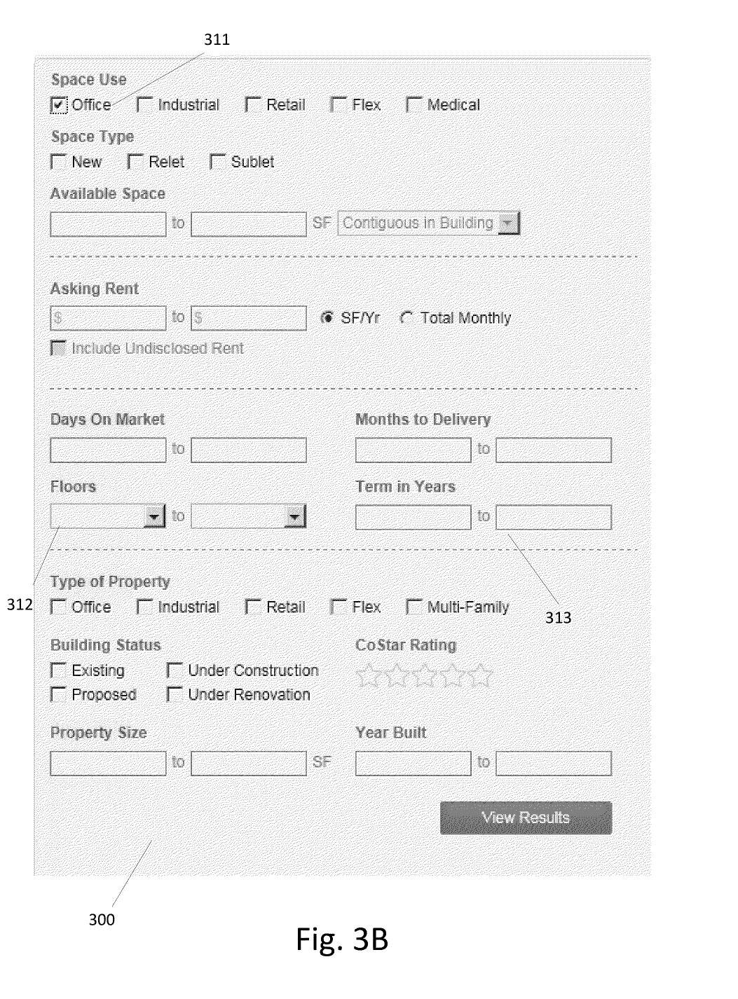

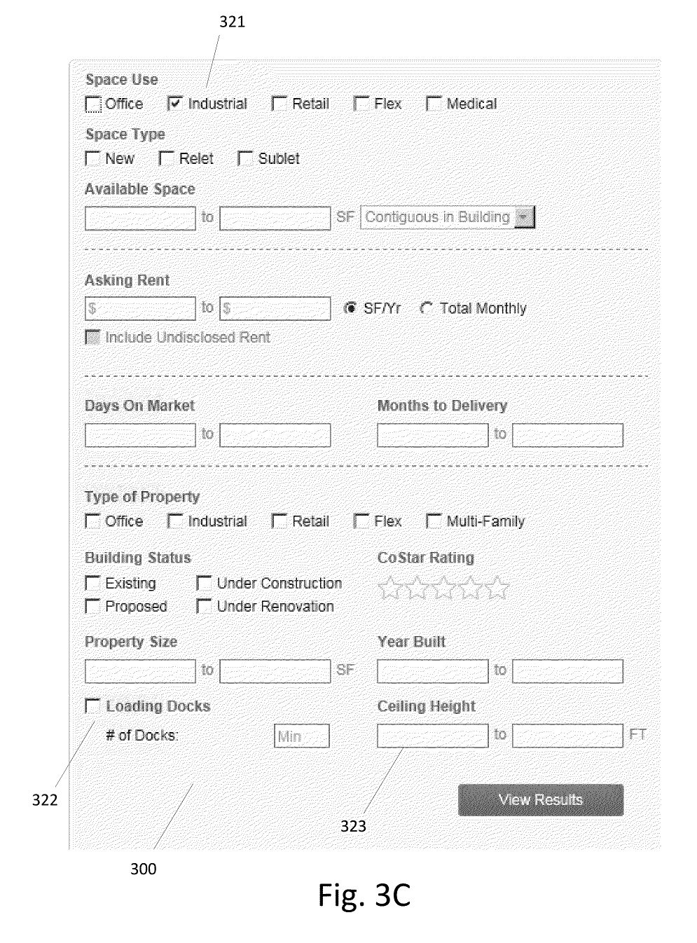

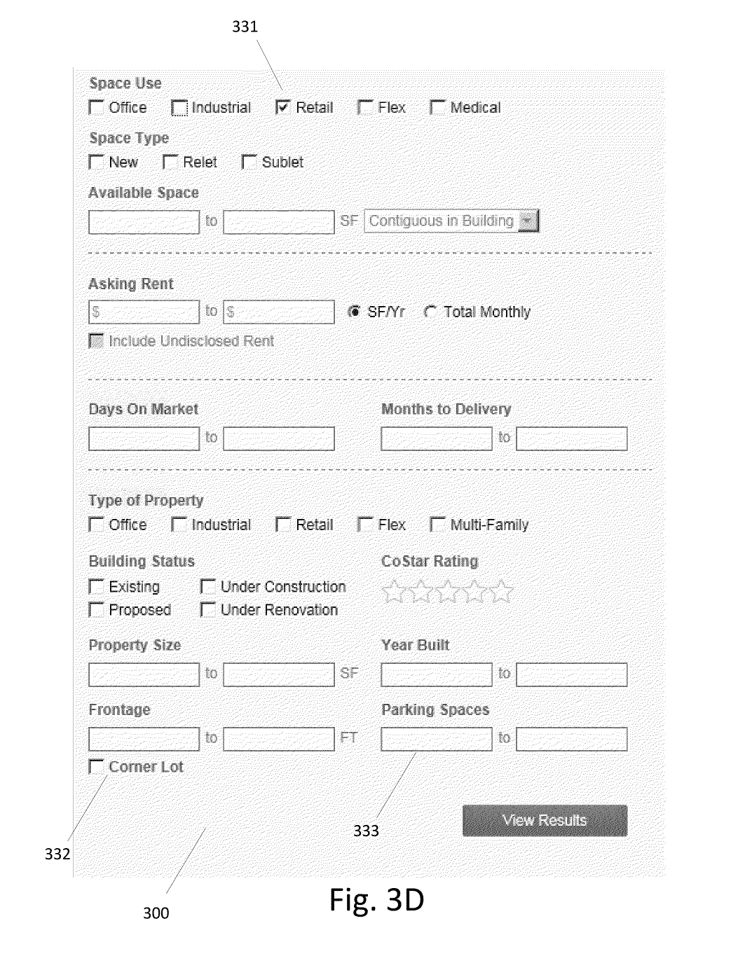

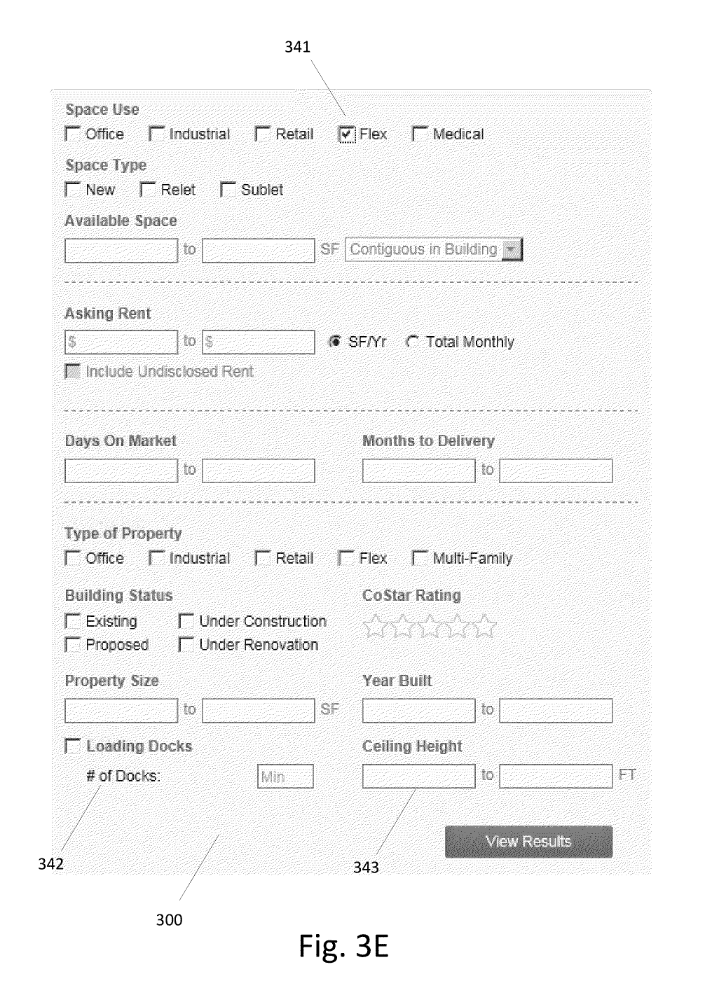

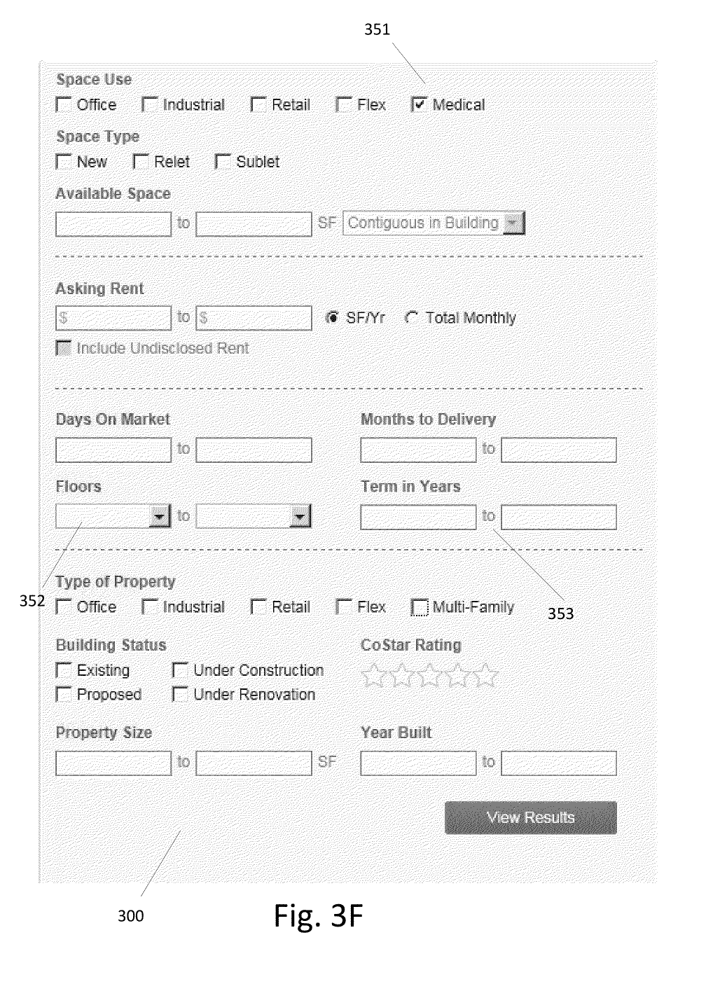

Some examples of dynamically updating search parameters for a real estate database are shown in FIGS. 3A-3F. FIG. 3A illustrates an interface 300 including a plurality of indicators 301 corresponding to a plurality of real estate uses. As shown in FIG. 3A, a real estate use has not been selected by a user. FIG. 3B illustrates the interface 300 after the user has selected real estate use indicator 311 corresponding to office use. As shown in FIG. 3B, the interface 300 has been updated to include a use-specific search parameter of floors 312 and a use-specific search parameter of a lease/rental term 313. These use-specific search parameters are provided for illustration only and are not intended to be limiting. Many other use-specific search parameters can be transmitted which correspond to office use.

FIG. 3C illustrates the interface 300 after the user has selected real estate use indicator 321 corresponding to industrial use. As shown in FIG. 3C, the interface 300 has been updated to include a use-specific search parameter of loading docks 322 which allows a user to specify whether they would like to filter real estate properties by availability of loading docks, as well as the minimum number of loading docks. Also included in the updated interface 300 is a use-specific search parameter of ceiling height 323. These use-specific search parameters are provided for illustration only and are not intended to be limiting. Many other use-specific search parameters can be transmitted which correspond to industrial use.

FIG. 3D illustrates the interface 300 after the user has selected real estate use indicator 331 corresponding to retail use. As shown in FIG. 3D, the interface 300 has been updated to include a use-specific search parameter of frontage 332 which allows a user to specify the amount of retail frontage they would like in a real estate property as well as whether the property is a corner lot. Also included in the updated interface 300 is a use-specific search parameter of parking spaces 333. These use-specific search parameters are provided for illustration only and are not intended to be limiting. Many other use-specific search parameters can be transmitted which correspond to retail use.

FIG. 3E illustrates the interface 300 after the user has selected real estate use indicator 341 corresponding to flex use. As shown in FIG. 3E, the interface 300 has been updated to include a use-specific search parameter of loading docks 342 which allows a user to specify whether they would like to filter real estate properties by availability of loading docks, as well as the minimum number of loading docks. Also included in the updated interface 300 is a use-specific search parameter of ceiling height 343. These use-specific search parameters are provided for illustration only and are not intended to be limiting. Many other use-specific search parameters can be transmitted which correspond to flex use.

FIG. 3F illustrates the interface 300 after the user has selected real estate use indicator 351 corresponding to medical use. As shown in FIG. 3F, the interface 300 has been updated to include a use-specific search parameter of floors 352 and a use-specific search parameter of a lease/rental term 353. These use-specific search parameters are provided for illustration only and are not intended to be limiting. Many other use-specific search parameters can be transmitted which correspond to medical use.

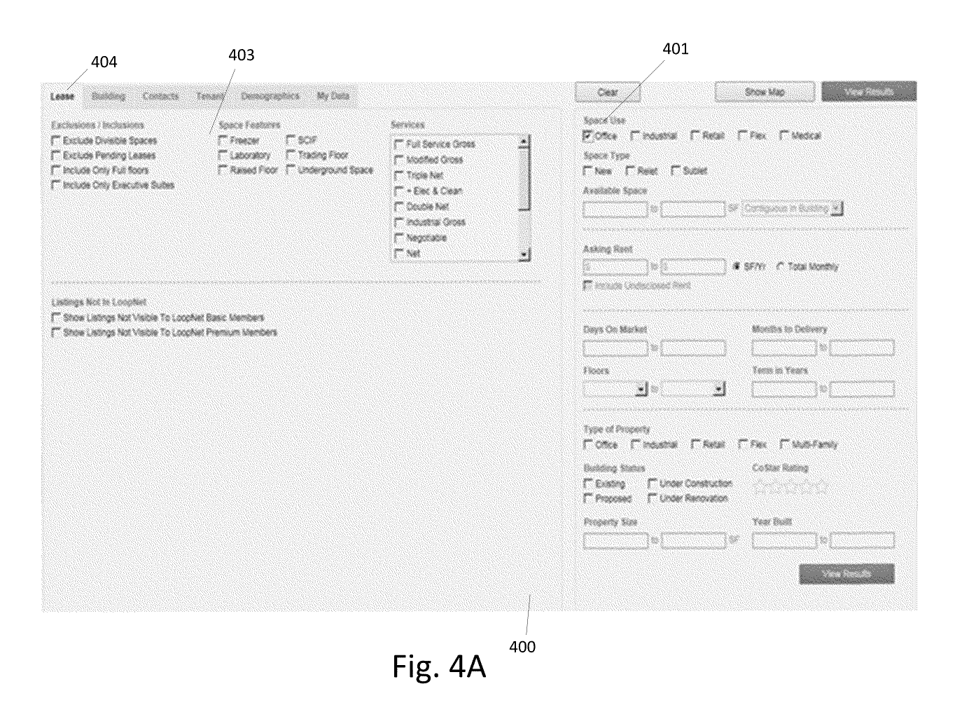

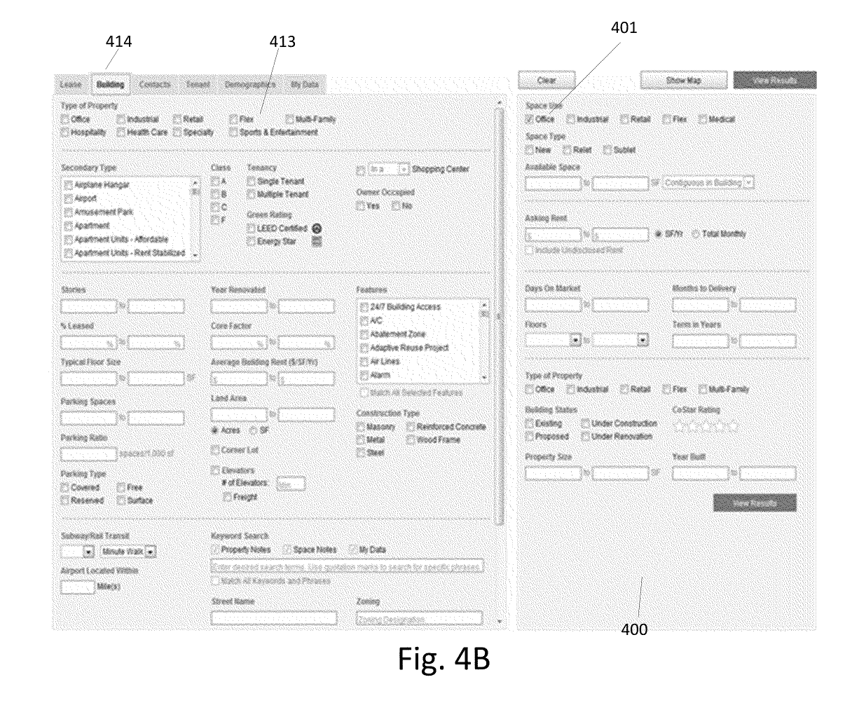

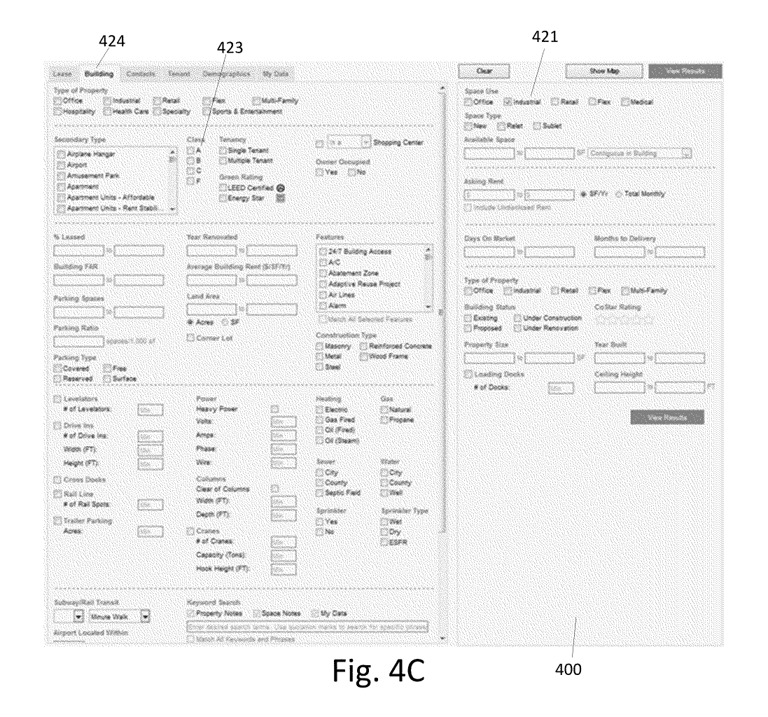

FIG. 4A illustrates an interface 400 that can be transmitted when the user selects the additional criteria 204 button shown in FIG. 2. Interface 400 includes an additional section 403 for a user to enter additional criteria and search parameters for their search of the real estate database. The additional section 403 can be organized into tabs as shown in the interface 400 of FIG. 4A. These tabs can be customized based on any selected real-estate uses. As shown in FIG. 4A, these tabs include a lease tab 404 (which has been selected by the user), a building tab, a contacts tab, a tenant tab, a demographics tab, and a “my data” tab which can include personalized search criteria. Additionally, the search parameters included in the additional section 403 can be customized based on any real estate uses selected by the use. In FIG. 4A, the user has selected the office use indicator 401 and the lease tab 404, so the search parameters in the additional section 403 can include use-specific search parameters corresponding to office use and lease characteristics.

FIG. 4B illustrates the interface 400 when the user has selected the building tab 414, resulting in additional section 413 being transmitted in the user interface 400 which includes search parameters relating to building characteristics. The search parameters presented in this additional section 413 can include use-specific search parameters based on the user's selection of the office use indicator 401.

FIG. 4C illustrates the interface 400 when the user has selected the building tab 424 and the real estate use indicator 421 corresponding to industrial use. This results in additional section 423 being transmitted in the user interface 400 which includes search parameters relating to building characteristics and which includes use-specific search parameters relating to industrial use. As shown in FIG. 4C, the use-specific search parameters in the additional section 423 are updated based on the selection of the real estate use indicator 421 corresponding to industrial use.

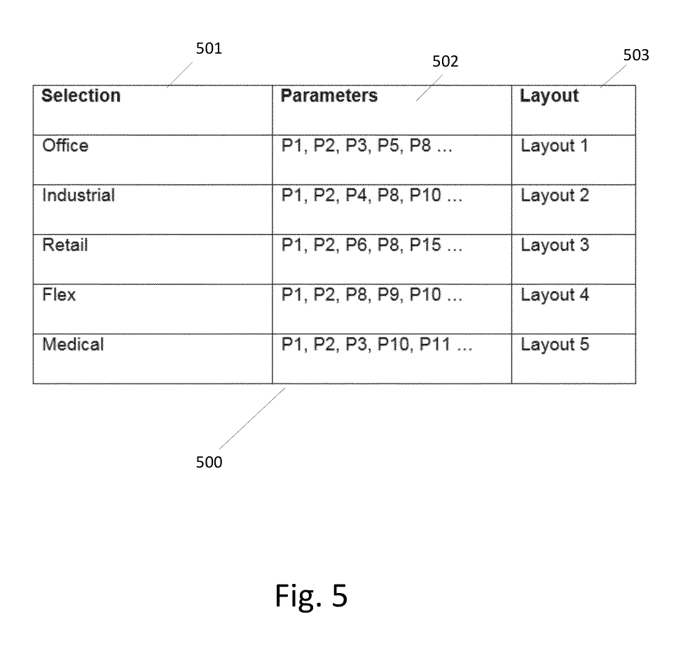

FIG. 5 illustrates a lookup table 500 that can be used to look up and retrieve the use-specific parameters corresponding to each real estate use according to an exemplary embodiment. As shown in the figure, the lookup table includes a column for real estate uses 501, along with a corresponding column for use-specific search parameters 502 corresponding to each real estate use. The lookup table 500 can also include a layout column 503 which stores layout information corresponding to each real estate use. This layout information can include one or more templates and can define the placement of search parameters and use-specific search parameters in a user interface when a corresponding real estate use indicator is selected. The layout information can include standard TCP/IP protocols, such as style sheets, active server pages and the like to provide the desired look and feel in a known manner. The use-specific search parameters can be controlled in a similar manner.

The method and system for dynamically updating search parameters for a real estate database transforms the data transmitted as part of the user interface, including the search parameters, to provide more relevant search options and parameters depending on the real estate use entered by the user. As described above, this can include transforming the code corresponding to the user interface elements. These features improve the performance, and ease-of-use of a computing device that is used to conduct a search of a real estate database by dynamically providing the most relevant search parameters to a user only after the user has specified a real estate use that they are interested in. Additionally, these features improve the layout and readability of the user interface transmitted to the user when conducting a search of the real estate database since the user is not presented with search parameters that are not relevant to the specific real estate use they are searching for.

Removing Search Results

When searching for real estate properties, a user often comes across search results that satisfy a valid query but, for various reasons, are not desirable to that specific user. Because of the subjective nature of, and multitude of variables in, selecting real property, even carefully crafted search queries will yield properties that are not desirable to the user. For example, the property might not be esthetically pleasing to the searcher.

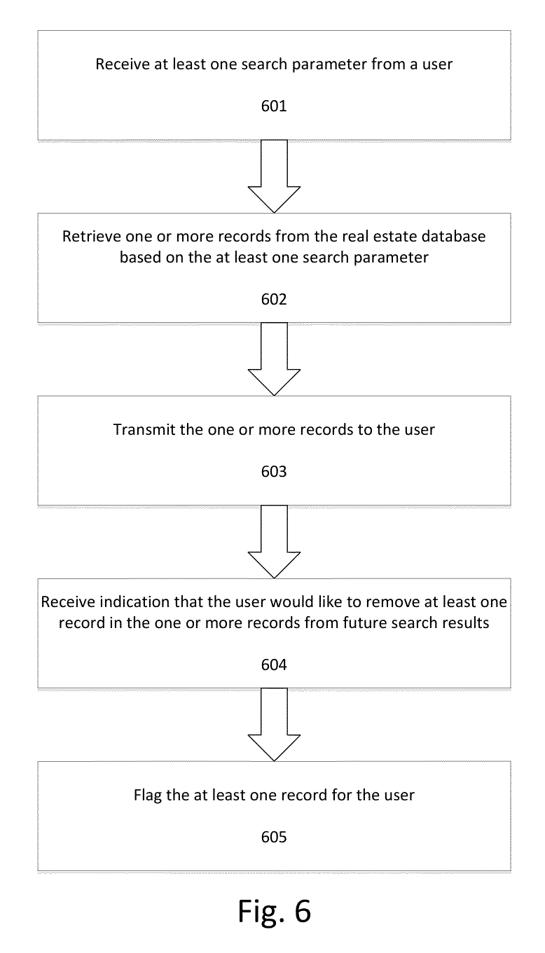

FIG. 6 is a flowchart illustrating a method for removing search results from a search of a real estate database. The real estate database can include records corresponding to real estate properties. At step 601 at least one search parameter is received from a user. The at least one search parameter(s) can be received via a user interface as described throughout this specification. At step 602 one or more records are retrieved from the real estate database based at least in part on the at least one search parameter. At step 603 the one or more records are transmitted to the user. The one or more records can be transmitted to the user in the user interface, such as part of a list of results or as icons on a map portion of the interface.

At step 604 an indication that the user would like to remove at least one record in the one or more records from future search results is received. This indication can be received through the user interface. For example, each record in the one or more records can have an associated indicator which is selectable by the user to indicate that they would like to remove that record from future search results. This indication can be received in other ways. For example, the user can select all the records that they would like removed, either on a map interface or in a list, and then select a “remove from search results” button to have all the selected records filtered from future search results. Alternatively or additionally, the user can drag the records that they would like to remove using a mouse pointer or touch gesture to a portion of the user interface which designates that those records should be removed. For example, the user interface can include a trash can icon or some other icon which indicates that records dragged over to the icon will be removed from future search results.

At step 605 at least one record for which the indication was received is flagged for the user. Flagged records are configured to be excluded from any results presented in response to queries by that user. Flagging can be performed by adding at least one record to an exclusion list of flagged records associated with an account of the user so that at least one record is automatically filtered from any future search results. For example, each user account can have an associated dynamic array of flagged records. When a record is flagged, a record identification number associated with the flagged record can be added to the dynamic array of flagged records associated with the user account. When any future results are retrieved, they can be cross-referenced with this dynamic array based on record identification numbers of each of the records in the results and record identification numbers stored in the dynamic array associated with the user account to filter out any unwanted records.

Flagging can also be performed by adding a tag to at least one record referencing the user and indicating that at least one record should be excluded from any results presented to the user. For example, each record in the database can have associated metadata which specifies a list of user accounts which have indicated they would like to remove that record from search results. When the record is flagged by a particular user, an account identification of that user's account can be added to the list of user accounts. When that record is retrieved in any future results, the account identification of the current user can be cross-referenced with the list of user accounts which have indicated they would like to remove that record from search results and the record can be filtered out of the search results if the current user account identification appears in the list.

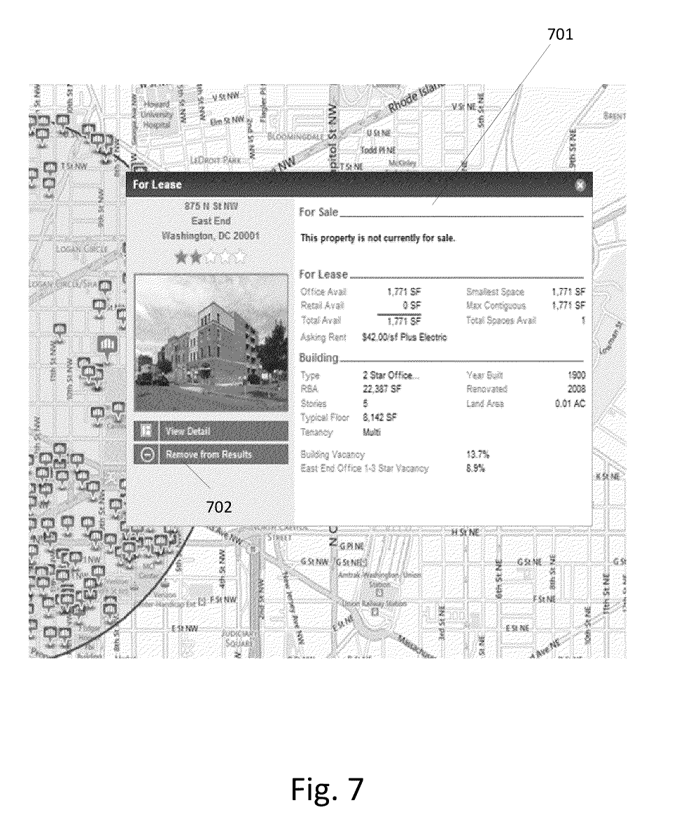

FIG. 7 illustrates an interface 701 which can be used to indicate that a user would like to remove a record from future search results according to an exemplary embodiment. As shown in the figure, interface 701 corresponds to a particular record in the database. Interface 701 can be presented in response to a selection of record either in a list of result records or as part of a map interface. Interface 701 includes a button 702 which allows the user to remove this record from results. After this button 702 is selected, the button can be replaced with a different button which allows the user to add the record back to the results. Once a record is flagged, it can be removed from all search results, even those for which it meets all search parameters.

Of course, users may change their mind about particular records and wish to add them back to future search results. In this case, a user can indicate that they would like to unflag/re-add records which they have removed. For example, the user interface can include an icon corresponding to flagged records and the user can select the icon to view all of the records that they have flagged. After the user indicates that they would like to unflag a record, a list of flagged records can be transmitted to the user. An indication that the user would like to include the at least one record in future search results can be received and the at least one record can then be unflagged for the user. This can be performed by, for example, removing the record from a dynamic array of flagged records associated with the user account or removing the user account identification from a list of blocking user accounts associated with the record.

Financial models can be useful for assessing potential real estate investments. One difficulty in creating financial models is the amount of data required and the many ways to express that data. For example, rent can be expressed as total yearly rent, total monthly rent, rent per square foot per year, and in other ways. Applicant has developed novel data structures and user interface elements to reduce the time and resources required for data entry.

The method and system for removing search results from a search of a real estate database transforms the data associated with each of the records in the real estate database by adding metadata indicating user accounts which would not like to receive the record in search result and/or the data associated with a particular account by adding a particular record identifier to a list of records that the user of the account would not like to receive in search results. These features improve the performance of a computing device that is used to conduct a search of a real estate database by increasing the efficiency of future searches conducted by the user. Additionally, the removal of unwanted records also allows the computing device to perform more accurate analytics and calculations on the results of a search, as the records which are not of interest to a user can be filtered out.

Generating a Financial Model

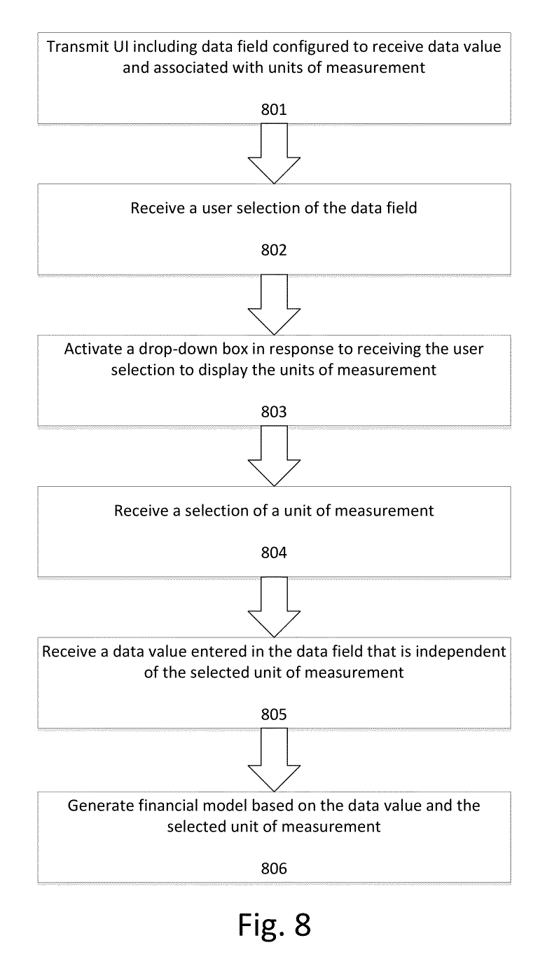

FIG. 8 is a flowchart illustrating a method for generating a financial model relating to real estate properties. At step 801 a user interface including a data field configured to receive a data value is transmitted. The data field is associated with a plurality of units of measurement. For example, a data field of “rental income” can be associated with a plurality of units of measurement of “total income per month,” “total income per year,” “monthly income per apartment,” “annual income per apartment,” etc. The association between the data field and the plurality of units of measurement can be stored in a data structure. For example, each data field can be stored as a data object which includes an array corresponding to a plurality of units of measurements for that data field.

At step 802 a user selection of the data field is received. This can include a user clicking on the data field with a pointing device or tapping the data field on a touch screen interface. This can also other actions such as the user hovering over the data field with a mouse or touchpad pointer or the user tabbing over to the data field from other data fields using a keyboard.

At step 803 a drop-down box is activated in response to receiving the user selection of the data field. The drop down box can be configured to display the plurality of units of measurement. The user interface code corresponding to the drop-down box can be configured to retrieve the plurality of units of measurement for that data field from a data object corresponding to that data field. The drop down box allows a user to select a unit of measurement from the plurality of units of measurements without compromising the user's ability to enter a data value in the data field, as will be described in greater detail below. The plurality of units of measurements can relate to measurements associated with real estate properties.

At step 804 a selection of a unit of measurement from the plurality of units of measurement displayed in the drop-down box is received. This can be received, for example, by the user clicking on one of the plurality of units of measurement.

At step 805 a data value entered in the data field is received. The received data value is not the previously selected unit of measurement and is independent of the selected unit of measurement, meaning that the interface allows the user to provide two unique inputs via a single user interface element (the data field).

For example, using the earlier example of a data field of “rental income,” after a user selects the data field, a drop down box can be activated which displays a list of units of measurement, including “total income per month,” “total income per year,” “monthly income per apartment,” and “annual income per apartment.” The user can select one of the units of measurement in the list. For example, a user can select “annual income per apartment.” The user can also enter a data value in the data field, such as “$10,000.” In this case, the entered data value of “$10,000” is independent of the selected unit of measurement of “annual income per apartment” in the sense that a selection of one does not in any way require the selection of the other. The user can enter any data value in the data field and select any unit of measurement in the drop-down box, with the data value and the unit of measurement being independent of each other. In this example, two unique inputs are received, one unique input is the data value of “$10,000” and the other unique input is the unit of measurement of “annual income per apartment.” This is in contrast to a conventional drop down box where a selection of an item in the drop down list mandates that the selected item is entered in the data field. The two received unique inputs can be stored in a data structure that is used to generate a mathematical model or perform some other computational function.

At step 806 a financial model is generated based at least in part on the data value and the selected unit of measurement. This unique data field combines what normally takes two input fields to capture data in a single data field. The advantage of this approach is that it significantly reduces (up to 100%) the number of input display items required to capture data, thus improving ease of use and allowing more data to be captured in a given space.

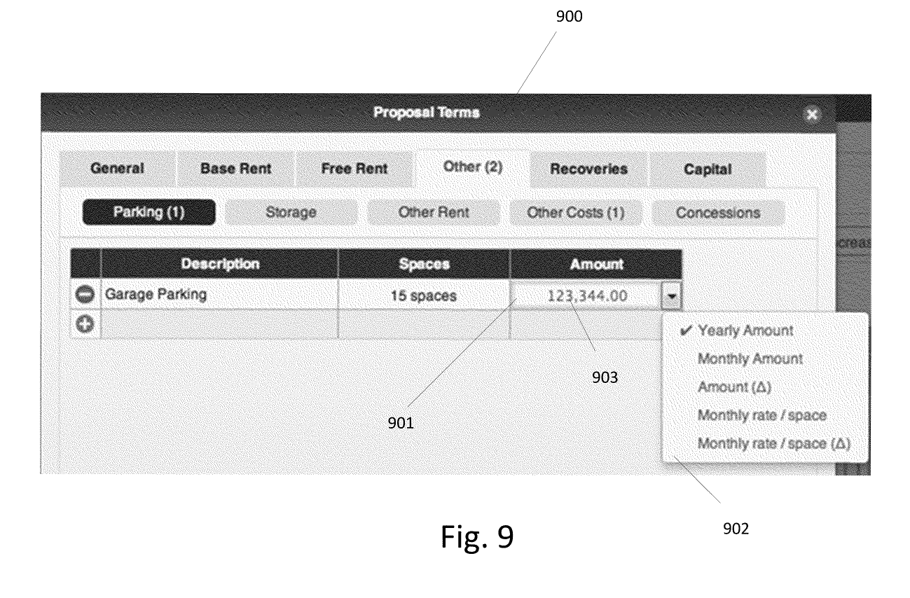

FIG. 9 shows an interface 900 demonstrating the above-described features. In the figure, the user has selected data field 901, causing the drop-down box 902 to be transmitted which includes a plurality of units of measurement. The user has selected one of the units of measurement in the drop down box 902, denoted by the check mark, and has also entered a data value 903 in the data field 904. After receiving the inputs shown in FIG. 9, a mathematical model can be generated based at least in part on the input of 123,344 dollars as the yearly amount generated by garage parking.

The method and system for generating a financial model relating to real estate properties improve the efficiency, performance, and ease-of-use of a computing device that is used to gather information for generating the model. By obtaining multiple input values from fewer user actions, a user can more quickly and easily provide the information necessary to generate the financial model. Additionally, the use of a data structure and corresponding user interface element which receives multiple inputs reduces the size and number of user interface elements that must be presented to a user, thereby reducing the amount of user interface code that must be transmitted to a user and the number of operations carried out by the computer in receiving and consolidating information received by the user. Furthermore, the multi-input data field described above improves the performance of software executing on the computer since fewer user interface elements means faster rendering and data capture, particularly in networked environments.

Transmitting Multi-Dimensional Data

Another problem in using financial models for real estate transactions, such as leases, is the amount of data that must be displayed and the number of dimensions of the data. There is currently no way to present multi-dimensional data for more than two dimensions in real estate financial models in an organized manner.

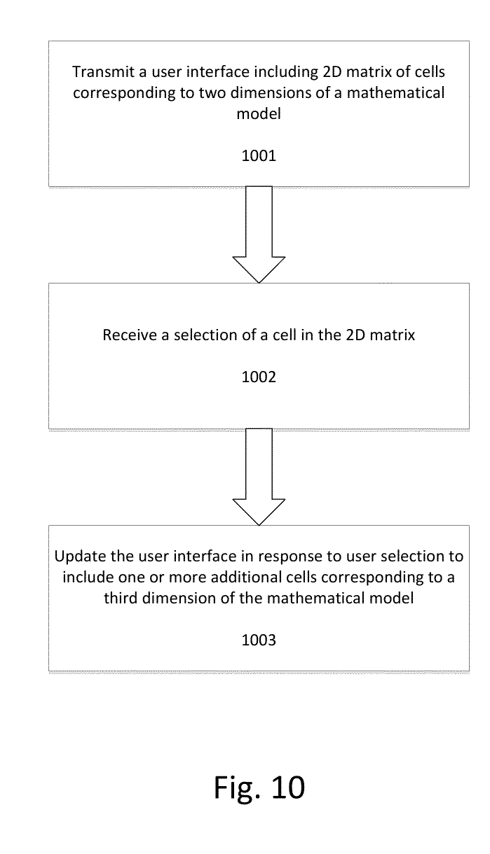

FIG. 10 is a flowchart illustrating a method for transmitting multi-dimensional data corresponding to real estate properties. At step 1001 a user interface including a two-dimensional matrix of cells corresponding to two dimensions of a mathematical model related to one or more real estate properties is transmitted. Each cell in the matrix corresponds to a two-dimensional location.

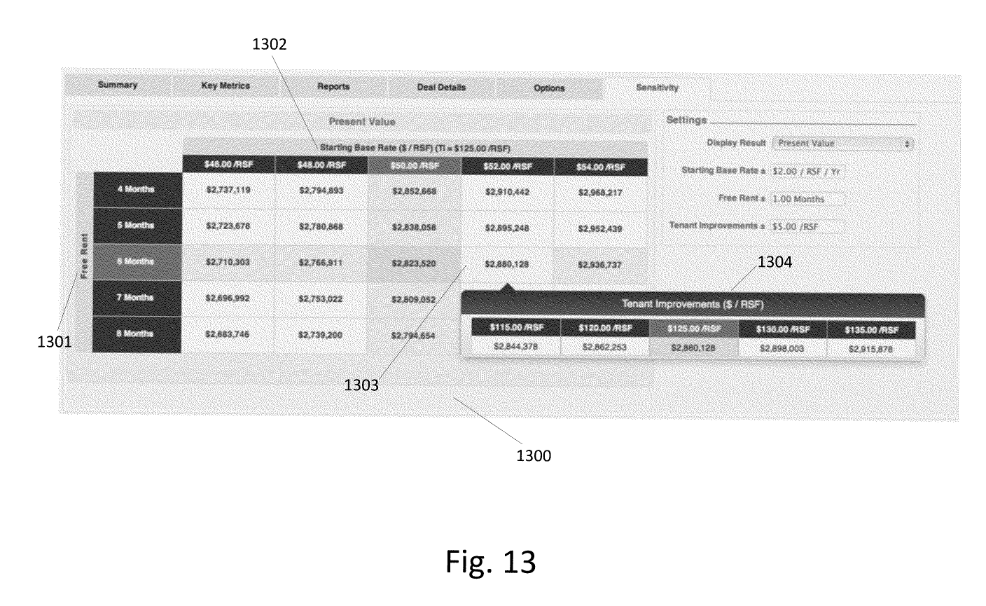

For example, FIG. 13 shows a user interface 1300 including a two-dimensional matrix of cells corresponding to two dimensions of a mathematical model showing present values of free rent based on a starting base rate 1302 which is expressed in dollars per rentable square foot (RSF) and a number of months of free rent 1301. In this example, each cell in the matrix corresponds to a two dimensional location, with the first dimension being a starting base rate ($/RSF) and the second dimension being the number of months of free rent. Landlords frequently provide free rent for a predetermined number of months in order to provide incentives to potential tenants to move-in. The matrix shown in the interface 1300 of FIG. 13 allows landlords to assess the present value of those free rent months based on base rental rates.

At step 1002 a user selection of a cell in the two-dimensional matrix is received. This can include a user clicking on the cell with a pointing device or tapping the cell on a touch screen interface. This can also other actions such as the user hovering over the cell with a mouse or touchpad pointer or the user tabbing over to the cell from other cells using a keyboard. As shown in FIG. 13, the user has selected cell 1303 in the matrix.

At step 1003 the user interface is updated in response to the user selection to include one or more additional cells corresponding to a third dimension of the mathematical model at the two-dimensional location of the selected cell.

As shown in FIG. 13, the selection of cell 1303 in the user interface 1300 results in the additional cells 1304 being transmitted in the user interface. The additional cells 1304 correspond to a third dimension of the mathematical model. In this case, the third dimension is value of tenant improvements in dollars per RSF and the additional cells 1304 correspond to different value of tenant improvements in dollars per RSF. Each of the additional cells 1304 represents a present value determination based on three dimensional values of free rent months, starting base rate, and tenant improvements. Additionally, each of the first two dimensional values are the same for all of the additional cells 1304 since all of the additional cells correspond to a third dimension of tenant improvements at the two dimensional location of 6 free rent months and a base rate of $52.00/RSF. As shown in FIG. 13, the interface 1300 allows the user to adjust the interval between each of the 3 items in the multi-dimensional display.

The third dimension calculations can be performed in advance and stored or performed on the fly only in response to selection of a field, i.e., after the field is selected, in to conserve resources and provide better responsiveness of the user interface.

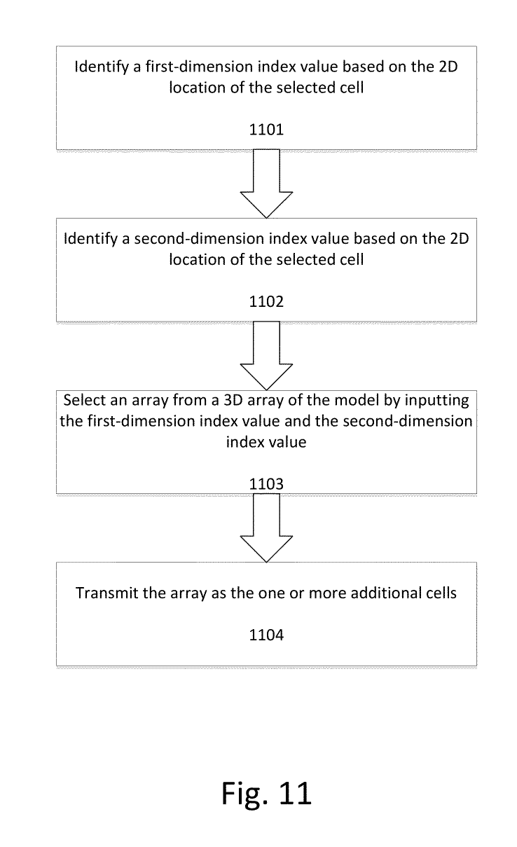

FIG. 11 is a flowchart illustrating a method for updating the user interface in response to a user selection, where the calculations for the third dimensional data are performed in advance.

At step 1101 a first-dimension index value is identified based on the two-dimensional location of the selected cell. Using the example of selected cell 1303 in FIG. 13, a first-dimension value can be identified as 6 months. The corresponding first-dimension index value can be determined based on the position of the first-dimension value relative to the other first-dimension values. For example, if we assume that the five “Month” values (4 months, 5 months, 6 months, 7 months, 8 months) shown in FIG. 13 are the only first-dimension values in the mathematical model, then the corresponding first-dimension index values for each would be [0], [1], [2], [3], and [4]. Of course, in practice the mathematical model will contain many more values than are displayed in the interface at given time. However, using our example for the sake of explanation, the first-dimension index value for the first-dimension value of 6 months would be [2].

At step 1102 a second-dimension index value is identified based on the two-dimensional location of the selected cell. Using the example of selected cell 1303 in FIG. 13, a second-dimension value can be identified as $52.00/RSF. The corresponding second-dimension index value can be determined based on the position of the second-dimension value relative to the other second-dimension values. For example, if we assume that the five “Starting Base Rate” values ($46, $48, $50, $52, $54) shown in FIG. 13 are the only second-dimension values in the mathematical model, then the corresponding second-dimension index values for each would be [0], [1], [2], [3], and [4]. Of course, in practice the mathematical model will contain many more values than are displayed in the interface at given time. However, using our example for the sake of explanation, the second-dimension index value for the second-dimension value of $52/RSF would be [3].

At step 1103 an array is selected from a three-dimensional array of the mathematical model by inputting the first-dimension index value as first index value into the three dimensional array and the second-dimension index value as a second index value into the three dimensional array. The three-dimensional array can correspond to pre-computed values of present values based on different data values in each of the three dimensions.

For example, the mathematical model shown in FIG. 13 can have a three dimensional array of present values based on months of free rent, starting base rate, and tenant improvements. This can be represented as:

presentValue[months of free rent][starting base rate][tenant improvements]

By inputting the first-dimension index value as first index value and inputting the second-dimension index value as a second index value into the presentValue array, the result will be a single dimensional array corresponding to the third dimension of present values based on tenant improvements. Using the example of FIG. 13, the additional cells 1304 corresponding to the third dimension of cell 1303 could be retrieved as:

additionalCells[ ]=presentValue[2][3]

This pseudo-code would result in assigning the present values corresponding to the third-dimension values for cell 1303 to the additionalCells[ ] array.

At step 1104 of FIG. 11, the one or more data values in the selected array are transmitted as the one or more additional cells corresponding to the third dimension. In the above example, the additionalCells[ ] array, or part of the additionalCells[ ] array, can be output as the additional cells 1304 in FIG. 13.

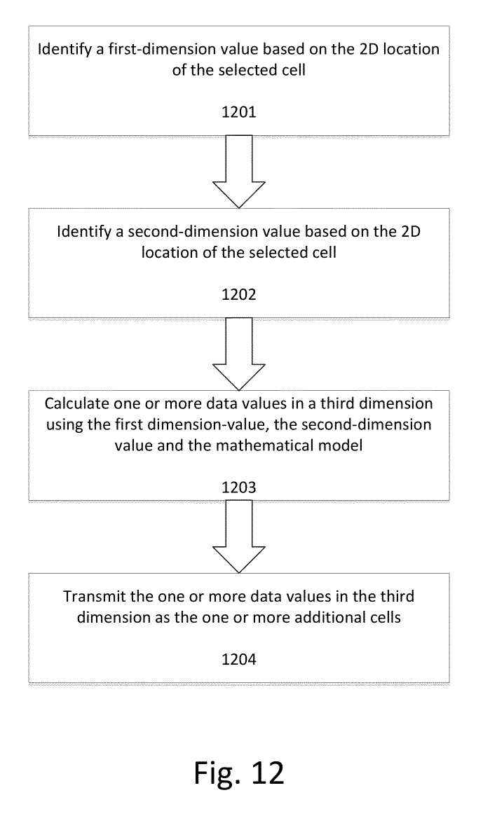

FIG. 12 is a flowchart illustrating a method for updating the user interface in response to a user selection, where the calculations for the third dimensional data are performed on the fly.

At step 1201 a first-dimension value is identified based on the two-dimensional location of the selected cell. Again using the example of FIG. 13, a first-dimension value for cell 1303 can be “6 Months.”

At step 1202 a second-dimension value is identified based on the two-dimensional location of the selected cell. Using the example of FIG. 13, a second-dimension value for cell 1303 can be “$52.00/RSF.”

At step 1203 one or more data values in a third dimension are calculated based at least in part on the first-dimension value, the second-dimension value, and the mathematical model. This can include providing the first-dimension value and the second-dimension value as constants to the mathematical model and generating one or more result data values corresponding to one or more possible third dimension data values. Using the example of FIG. 13, the values of “6 months” and “52.00/RSF” can be input to the mathematical model as constants corresponding to the number of free rent months and the starting base rate. The model can then calculate different possible values of present value for different possible values of tenant improvements.

At step 1204, the one or more data values in the third dimension are transmitted as the one or more additional cells corresponding to the third dimension, such as cells 1304 shown in FIG. 13.

The method for transmitting multi-dimensional data can be repeated for additional dimensions. For example, a user can select a cell in the additional cells corresponding to three dimensional data and bring up another set of cells corresponding to four-dimensional data.

The method and system for transmitting multi-dimensional data improve the efficiency, performance, and ease-of-use of a computing device that is used to transmit multi-dimensional data. Ordinarily, transmitting information in more than two dimensions is computationally expensive, as it requires not only three-dimensional graphics rendering but also the computation of all three dimensional values corresponding to each two-dimensional data point prior to rendering. However, the present method and system for transmitting multi-dimensional data increases the computational performance of a computing device by allowing for more than two dimensions of data to be presented accurately and quickly using only a two dimensional space, with no three-dimensional graphics processing required. Additionally, the present method and system for transmitting multi-dimensional data increases the computational performance of a computing device by providing three-plus dimensional data upon request for a particular data point that is selected by the user, making it unnecessary to perform three-dimensional calculations for all two-dimensional data points in the model. Furthermore, while many three-dimensional models and graphs can be difficult to read, the present method and system for transmitting multi-dimensional data improves the performance of a computing device by presenting three-dimensional information in a tabular format which is easily readable.

Customized Analytics

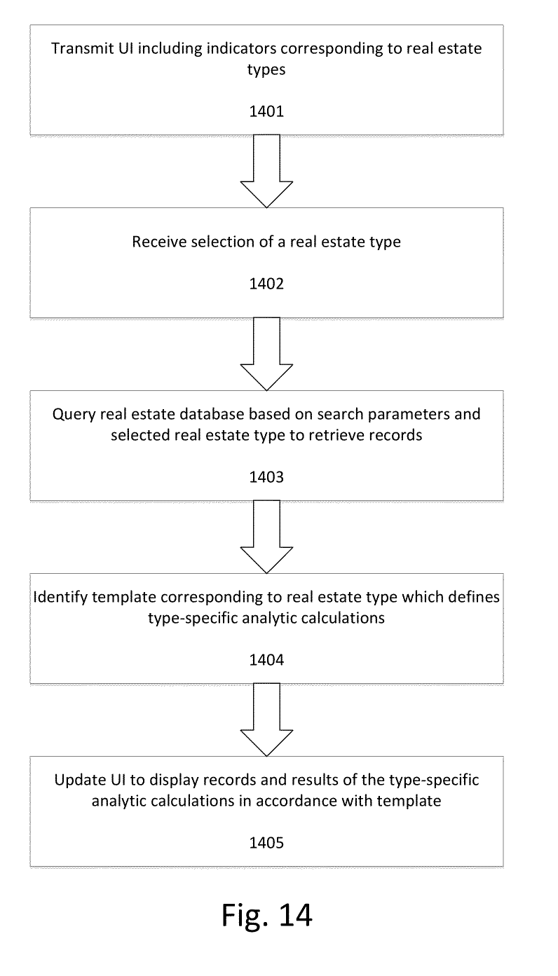

FIG. 14 is a flowchart illustrating a method for providing customized analytics based on search results from a real estate database, the real estate database including records corresponding to real estate properties. At step 1401 a user interface including a plurality of indicators corresponding to a plurality of real estate types is transmitted to a user. The plurality of real estate types can include a variety of types of real estate, such as office, industrial, retail, flex, and multi-family, as shown in FIG. 2 and FIGS. 3A-3F.

At step 1402 a selection of a real estate type in the plurality of real estate types is received through the selection of an indicator in the plurality of indicators. Optionally, more than one real estate type can be selected.

At step 1403 the real estate database is queried based at least in part on one or more search parameters entered by a user and the selected real estate type to retrieve one or more records responsive to the one or more search parameters. The one or more search parameters can include any of the search parameters previously discussed, including use-specific parameters or any other search parameters relating to real estate characteristics or location characteristics, such as country code.

At step 1404 a template corresponding to the selected real estate type identified. The template can be identified from a plurality of templates by querying a data structure storing a mapping of the plurality of real estate types to a plurality of templates, such as a lookup table. The plurality of templates can define one or more type-specific analytic calculations corresponding to each real estate type and the identified template can define one or more type-specific analytic calculations corresponding to the selected real estate type. For example, the template for the office type can include different analytic calculations than the template for the multi-family type. Additionally, the plurality of templates can include combination templates corresponding to selections of multiple types of real estate, such as office and flex. These combination templates can include analytics directed to the combination of the selected real estate types.

Additionally, a template can be identified in the plurality of templates based on inputs other than or in addition to a property type. For example, the user interface can include a plurality of indicators corresponding to a plurality of search modes. The search modes can include categories such as For Lease, For Sale, Lease Deals, Sale Comps, Properties, Tenant, etc. A user can select one or more search modes through the selection of one or more of the plurality of indicators corresponding to the plurality of search modes. The search mode can be selected in addition to or instead of a property type. The selected search mode can be used alone or in combination with a property type or any other search parameters to identify a template in the plurality of templates. The identified template can include one or more analytic calculations customized to the particular selection of search parameters. For example, a template can be identified based on a selected search mode, a selected property type, and a selected country code.

The list of analytic calculation results, charts, and/or summaries that need to be displayed for a particular template can be defined as metadata. The template can be divided into several sections and can store information indicating when each section should be displayed, such as for particular search modes or particular property types.

Optionally, a master template can be utilized and customized to each particular search query based on the search parameters, property type, search mode, geographic information, or any other parameters. For example, after a search request is processed, one or more analytic sections (such analytic calculations, graphs, summaries, etc.) in the master template can be filtered based on a country code in the request. This will return only analytic sections that are applicable to a given country. The remaining analytic sections can be filtered based on any search modes specified in the search request and then further filtered based on any property types specified in the request. The remaining analytic sections can be sorted in a predetermined order based on the search parameters, search modes, and/or property types specified in the search request.

Optionally, an analytics indicator can be transmitted to the user in the user interface prior to identifying the template or querying the database. The analytics indicator can be a button, switch, data field, or other user interface element that allows the user to toggle analytics on or off. For example, if the user simply wishes to retrieve real estate records without viewing any analytics, they can toggle the analytics indicator off. Otherwise they can toggle the analytics indicator on. Additionally, the analytics indicator can be toggled to provide only analytics and no search results, in case the user is interested in investigating broad trends but not searching for a specific property.

At step 1405 the user interface is updated to display at least one of the one or more records that are responsive to the one or more search parameters and display results of the one or more type-specific analytic calculations in accordance with a layout of the template. The template can specify the locations of results of the analytic calculations, as well the locations of any result records that are displayed. Additionally, the results of the one or more type-specific analytic calculations can be presented in many forms, such as numerical data, a table, a chart, a graph, etc.

For each analytic section or analytic calculation, one or more necessary criteria or data values for the analytic section or calculation can be retrieved and inserted and used to generate the results which are presented to the user.

The data set that the analytic calculations are performed on can be specified by the user via the user interface. For example, the results of the one or more type-specific analytic calculations can be determined by performing the one or more type-specific analytic calculations on the one or more records that are responsive to the one or more search parameters. This allows the user to view aggregated information regarding all of the records that responsive to their search query and search parameters and which is customized to the type of real estate they are looking for.

Alternatively, the results of the one or more type-specific analytic calculations can be determined by performing the one or more type-specific analytic calculations on records in the real estate database corresponding to the selected real estate type and including records that are not responsive to the one or more search parameters. This allows the user to assess the aggregated information and analytics for records which are the same real estate type as those searched for but which might not necessarily meet all of the criteria specified by the search parameters.

The user interface can be updated dynamically in response to any inputs by the user. For example one or more new search parameters can be received from a user via the user interface or a different real estate type can be selected. The real estate database can be queried based at least in part on the one or more new search parameters and any selected real estate type to identify one or more new records. The user interface can then be updated to display at least one of the one or more new records and updated results of the one or more type-specific analytic calculations based at least in part on the one or more new records.

For example, after displaying aggregated analytics (an analytic summary and charts) based on a set of properties returned from the search criteria, the user can change the geographic criteria on the map, return a different set of properties and view the aggregated analytics for that unique, customized search instantly. This allows the client device to present analytic charts and analytic summary based on an infinite variation of customized geographic searches.

Additionally, users can remove records from the search results and/or from one or more type-specific analytic calculations. This functionality can be implemented in a similar way to the flagging functionality described earlier. An indication that a user would like to remove at least one record in the one or more records from search results can first be received. The at least one record can be removed from the one or more records that are responsive to the one or more search parameters. Additionally the user interface can be updated to display updated results of the one or more type-specific analytic calculations based at least in part on the records remaining in the one or more records that are responsive to the one or more search parameters.

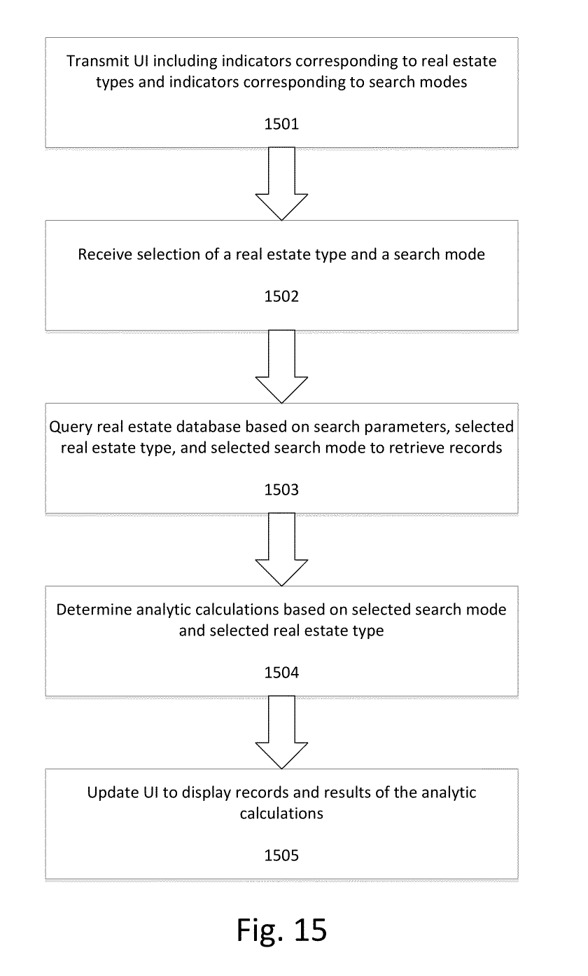

As discussed above, there are many ways to provides customized analytics to a user based on search parameters. FIG. 15 is another flowchart illustrating another method for providing customized analytics based on search results from a real estate database, the real estate database including records corresponding to real estate properties.

At step 1501, a user interface including a plurality of indicators corresponding to a plurality of real estate types and a plurality of second indicators corresponding to a plurality of search modes is transmitted to a user.

At step 1502 a selection of a real estate type in the plurality of real estate types is received through the selection of an indicator in the plurality of indicators and a selection of a search mode in the plurality of search modes is received through the selection of a second indicator in the plurality of second indicators.

At step 1503 the real estate database is queried based at least in part on one or more received search parameters (e.g., a real estate characteristic or location characteristic such as a country code), the selected real estate type, and the selected search mode to retrieve one or more records. At step 1504 one or more analytic calculations are determined based at least in part on the selected search mode and the selected real estate type. Additionally, at step 1505 the user interface is updated to display at least one of the one or more records and display results of the one or more analytic calculations.

The results of the one or more analytic calculations can be determined by performing the one or more analytic calculations on the one or more records. Alternatively, the results of the one or more analytic calculations can be determined by performing the one or more analytic calculations on a set of records in the real estate database that includes records that are not responsive to the one or more search parameters.

Additionally, users can remove records from the search results and/or from one or more analytic calculations. This functionality can be implemented in a similar way to the flagging functionality described earlier. An indication that a user would like to remove at least one record in the one or more records from search results can first be received. The at least one record can be removed from the one or more records that are responsive to the one or more search parameters. Additionally the user interface can be updated to display updated results of the one or more analytic calculations based at least in part on the records remaining in the one or more records that are responsive to the one or more search parameters.

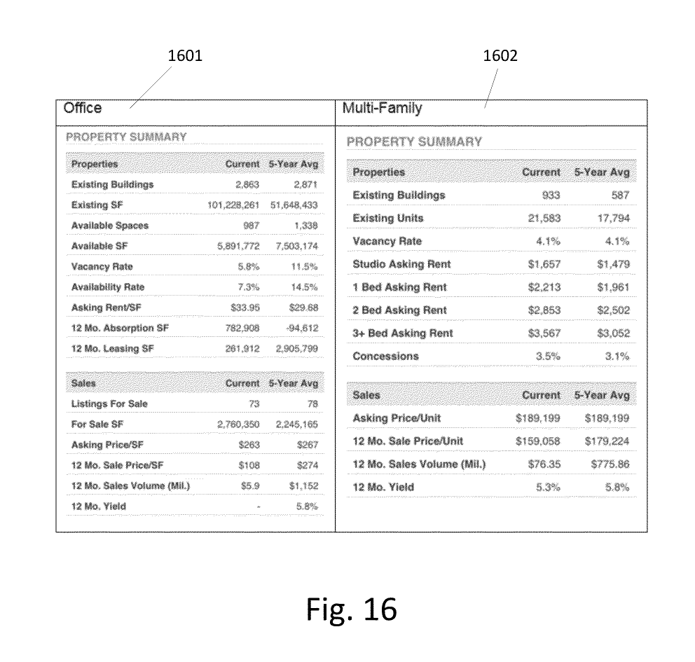

FIG. 16 illustrates examples of the results of analytics corresponding to different property types in a property search mode. Section 1601 illustrates results of type-specific analytics corresponding to the office type and section 1602 illustrates results of type-specific analytics corresponding to the multi-family type.

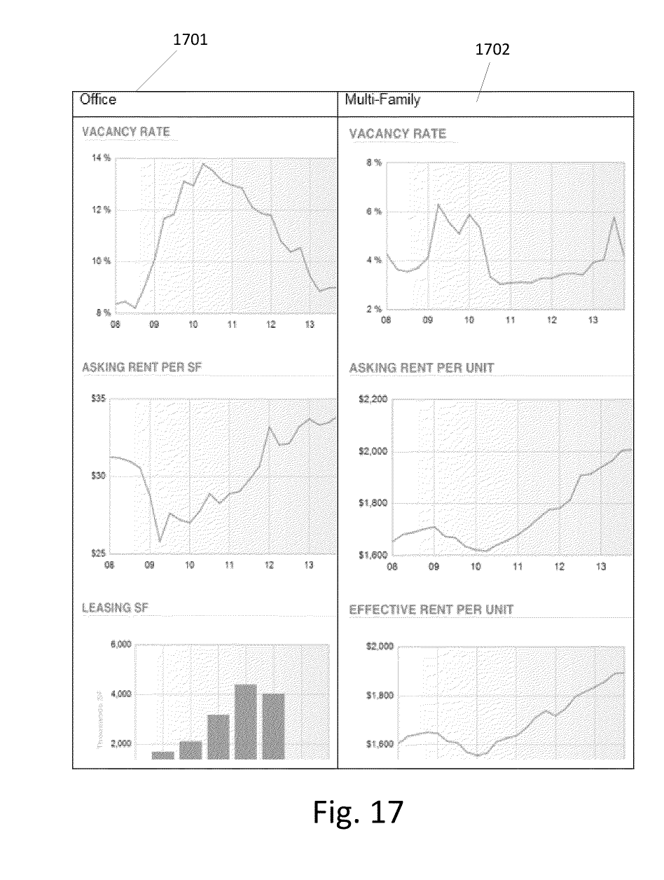

FIG. 17 illustrates additional examples of the results of analytics corresponding to different property types in a property search mode. Section 1701 illustrates results of type-specific analytics corresponding to the office type and section 1702 illustrates results of type-specific analytics corresponding to the multi-family type. As shown in this figure, the results can include charts and graphs. Of course, these examples are provided for illustration only, and a variety of analytics can be used for each of the different property types and/or search modes.

The method and system for providing customized analytics based on search results from a real estate database transforms the data transmitted as part of the user interface, including the analytic calculations pertaining to the search results, to provide more relevant analytical information depending on the real estate type, search mode, or other parameters entered by the user. As described above, this can include transforming the code corresponding to the user interface elements as well as the code corresponding to templates which are used to select the relevant analytics. These features improve the performance, and ease-of-use of a computing device that is used to conduct research on a real estate database by dynamically providing the most analytical information to a user only after the user has specified a real estate type, search mode, or other parameter that they are interested in. Additionally, these features improve the efficiency of the computing device since the user does not have to select the analytical calculations that they would like to be performed and the relevant analytical calculations are automatically determined based on the types of property the user is interested in.

Aggregating Results by Tenant

One or more tenants occupy commercial buildings typically. This can be characterized in terms of square feet occupied. The tenants in a building also typically have a lease, which can be for certain number of years or on month-to-month basis. In addition, tenants usually represent companies and report to a parent company which is typically a Head Quarters (HQ) or Regional HQ.

For example, a tenant ABC Corporation occupies 10,000 square feet in downtown Washington, D.C. building with a lease for 5 years. This tenant also occupies a few other buildings in the surrounding DC metro area and other states in the nation. Let's say the tenant reports to HQ in New York, N.Y. When presenting aggregate analytics that display a subset or all of these tenants on a map, it would be helpful to users to aggregate the analytic information for all the tenants in order to provide an accurate representation of the tenant demographics in a region. For example, when aggregating square occupied by tenant, it would be helpful in presenting a clearer picture to user of the tenant demographics to sum all square feet occupied for tenants that report to the same company.

Applicant has developed a system and method for aggregating analytic tenant information and presenting the information as a chart or summary data for various measures such as square feet occupied, counts of tenants occupying certain square feet range, count of tenants in a specific industry based on Standard Industrial Classification (SIC) code, and how much space will become available based on lease expiration dates.

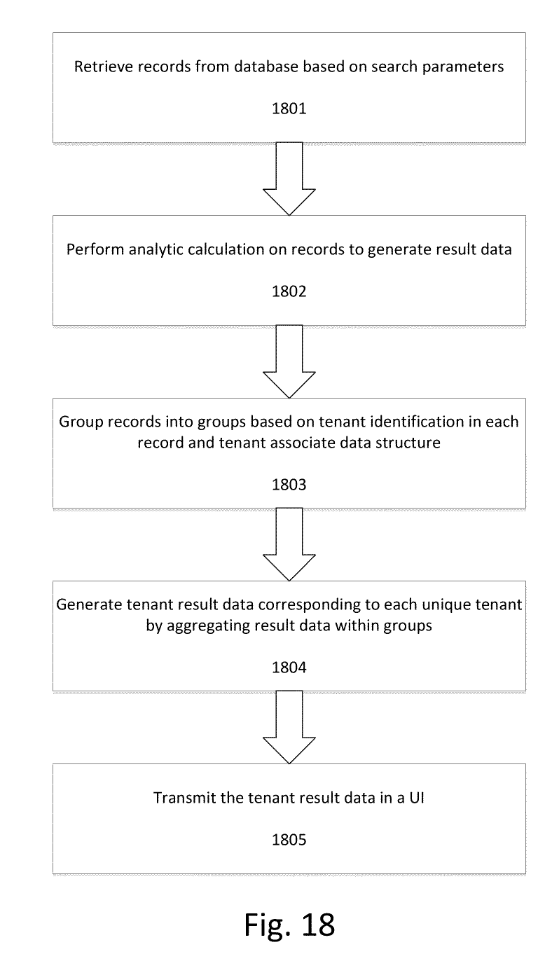

FIG. 18 is a flowchart illustrating a method for aggregating search results by tenant according to an exemplary embodiment. At step 1801 a plurality of records from a real estate database are retrieved based at least in part on one or more search parameters, wherein the each record in the plurality of records corresponds to a unique real estate property and includes a tenant identification. This retrieval can performed as described throughout the previous sections of the application.

At step 1802 at least one analytic calculation is performed on the plurality of records to generate result data. As discussed earlier, the at least one analytic calculation can include a determination of square feet associated with each record. Additionally, the records can include lease information, in which case the at least one analytic can include a determination of a lease expiration date or time period. These example are provided for illustration only and many other analytic calculations can be performed on the data stored in the real estate records retrieved from the database.

At step 1803 the plurality of records are grouped into a plurality of groups based at least in part on the tenant identification included each record and a tenant association data structure which defines one or more associations between a plurality of tenant identifications, wherein each group in the plurality of groups corresponds to a unique tenant in a plurality of unique tenants, and wherein each unique tenant has an associated tenant identification.

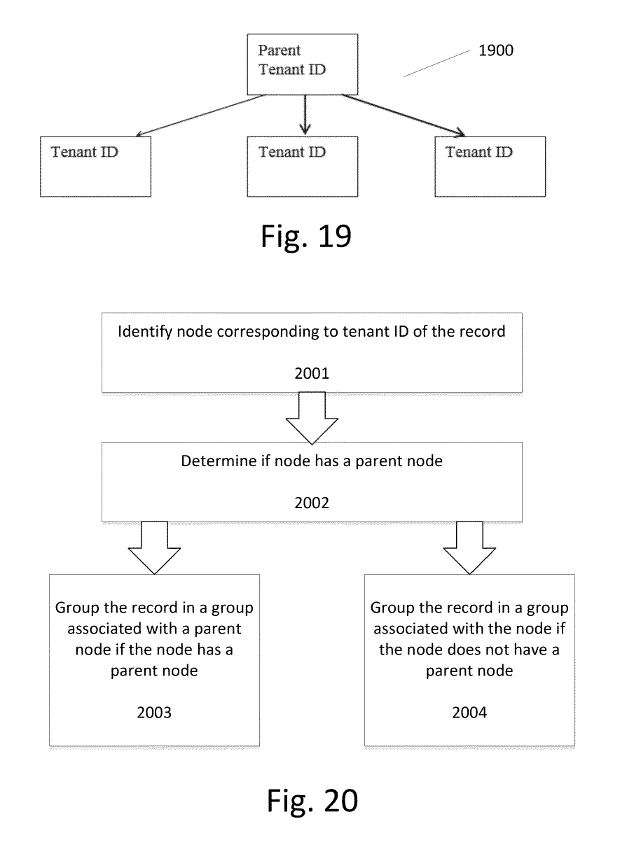

FIG. 19 illustrates an example of a tenant association data structure 1900 defining associations between a plurality of tenant identifications. In this case, the tenant association data structure 1900 is a tree structure which stores hierarchical information regarding which tenant identifications correspond to parent tenants and which tenant identifications correspond to child tenants. This structure can be used, for example, to determine if a particular tenant is a subsidiary of another tenant (such as a parent company). Additionally, the tenant identifications can be stored within a tree structure based on characteristics other than parent company or subsidiary company, such as industry, location, or some other characteristic. Of course, this data structure is provided as an example only and other tenant association data structures are possible. For example, the tenant association data structure could be a lookup table with an entry for each tenant identification.

FIG. 20 is a flowchart illustrating a method for grouping the plurality of records into a plurality of groups when the tenant association data structure comprises a tree of tenant identifications according to an exemplary embodiment. The method can be performed for each record in the plurality of records to group the plurality of records into groups.

A step 2001 a node in the tree corresponding to the tenant identification of the record is identified. At step 2002 it is determined whether the node has a parent node. At step 2003 the record is grouped into a group associated with the parent node based at least in part on a determination that the node has a parent node. Alternatively, at step 2004 the record is grouped into a group associated with the node based at least in part on a determination that the node does not have a parent node.

Of course, the parent node of the node corresponding to record may itself have a grandparent node. To deal with this possibility, the method can include determining whether the parent node has a grandparent node and grouping the record into a group associated with the grandparent node based at least in part on a determination that the parent node has a grandparent node. This process can be repeated upward through the hierarchy of the tree until all records are either assigned to a group associated with the highest parent of the node that corresponds to the record assigned to a group associated with the node that corresponds to the record if there are no parents.

At the end of the grouping process, all the records will be in a group corresponding to a unique tenant, with an associated tenant identification. Returning to FIG. 18, at step 1804 tenant result data corresponding to each unique tenant in the plurality of unique tenants is generated by aggregating the result data within each group in the plurality of groups. So the result data corresponding to all of the records each is group is combined to generate the tenant result data. For example, if the result data for each record included the square feet occupied for that record, then the tenant result data for each unique tenant would be the sum of the square feet occupied for each of the records in the group corresponding to the unique tenant.

To provide an illustrative example, if company ABC is a subsidiary of company XYZ and company ABC has two records in the database, each record listing 500 square feet, and company XYZ has one record in the database listing 1,000 square feet, then after step 1804, the tenant result data would include an aggregate of 2,000 square feet corresponding to unique tenant XYZ.

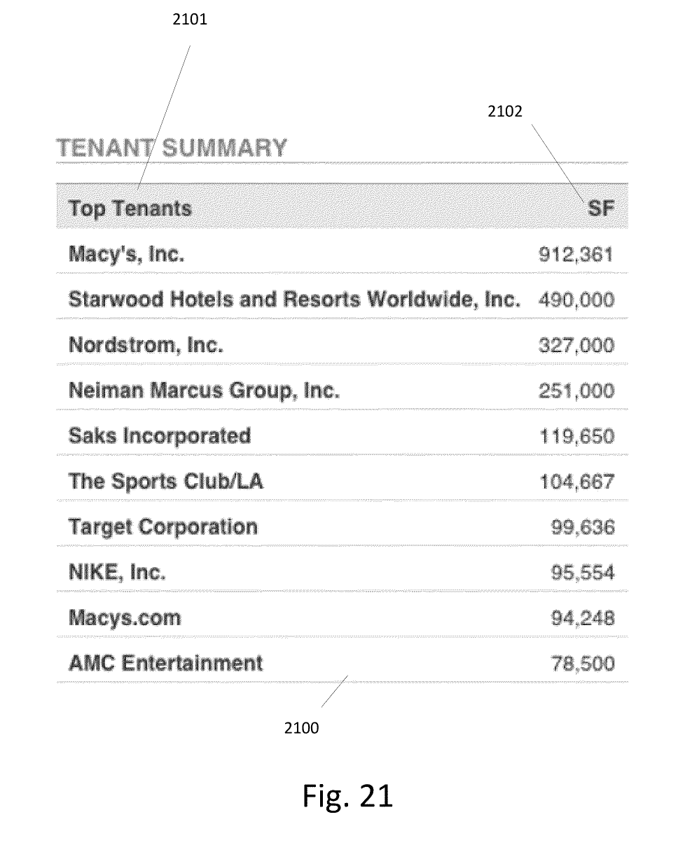

At step 1805 the tenant result data is transmitted in a user interface. Transmitting the tenant result data can include transmitting one or more tenant identifications corresponding to one or more unique tenants in the plurality of unique tenants and transmitting tenant result data corresponding to each unique tenant in the one or more unique tenants. For example, FIG. 21 illustrates a tenant results interface 2100 including a list of unique tenants 2101 and the tenant result data corresponding to each unique tenant (in this case an aggregation of square feet associated with each tenant).

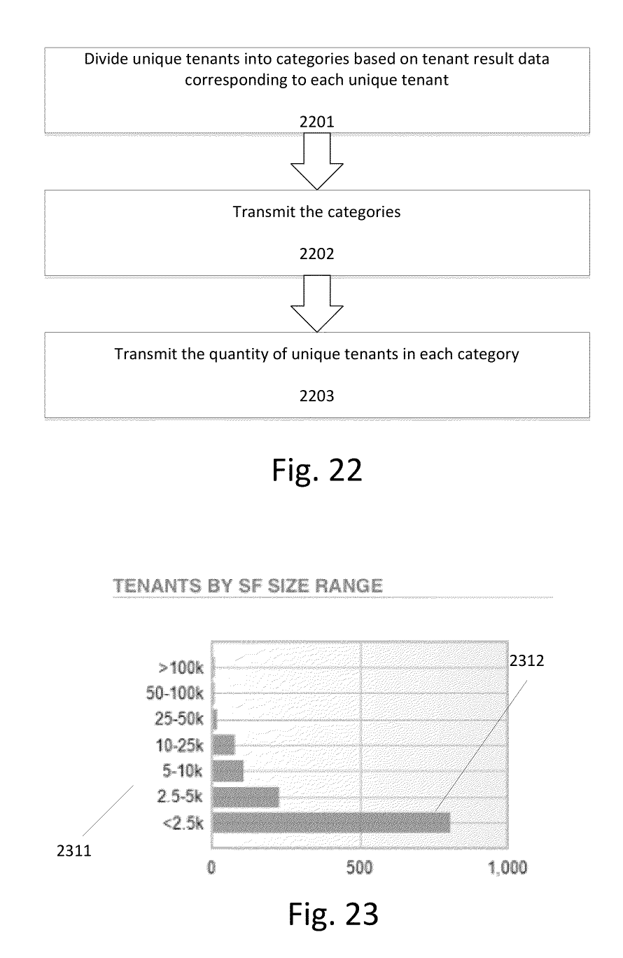

The tenant result data can also be processed and/or transmitted in other ways. FIG. 22 is a flowchart illustrating a method for transmitting the tenant result data according to an exemplary embodiment. At step 2201 the plurality of unique tenants are divided into one or more categories based at least in part on the tenant result data corresponding to each unique tenant. At step 2202 the one or more categories are transmitted in the user interface and at step 2203 the quantity of unique tenants in each of the one or more categories is transmitted in the user interface. Steps 2202 and 2203 can be performed at the same time.

FIG. 23 illustrates an example of the method of transmitting tenant result data described with regard to FIG. 22. In this figure, the plurality of unique tenants have been divided into categories corresponding to total square feet associated with each unique tenant. These categories include >100 k total square feet, 50-100 k square feet, 25-50 k square feet, etc. The number of unique tenants in each category is depicted as a horizontal bar 2312 in the graph.

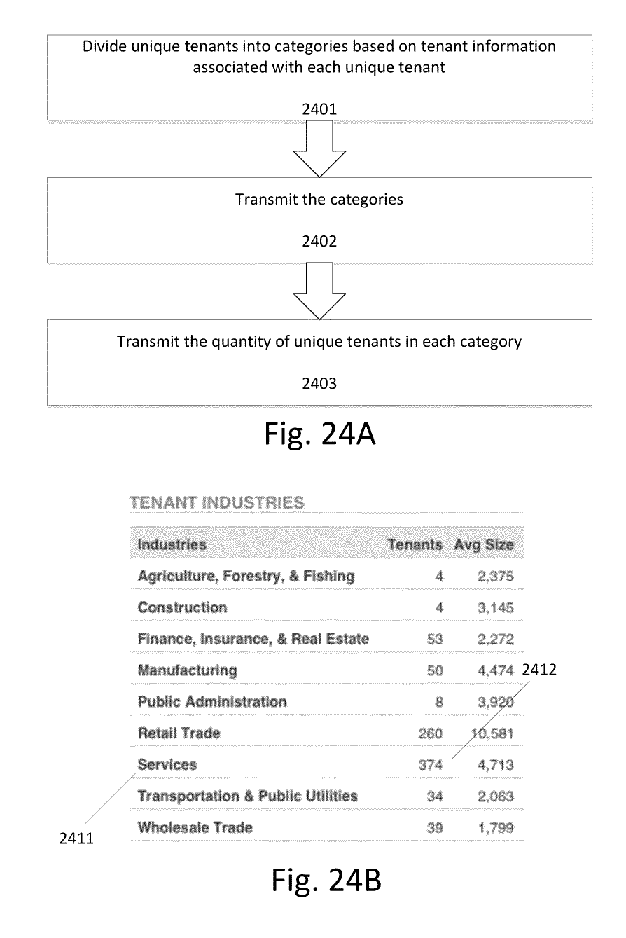

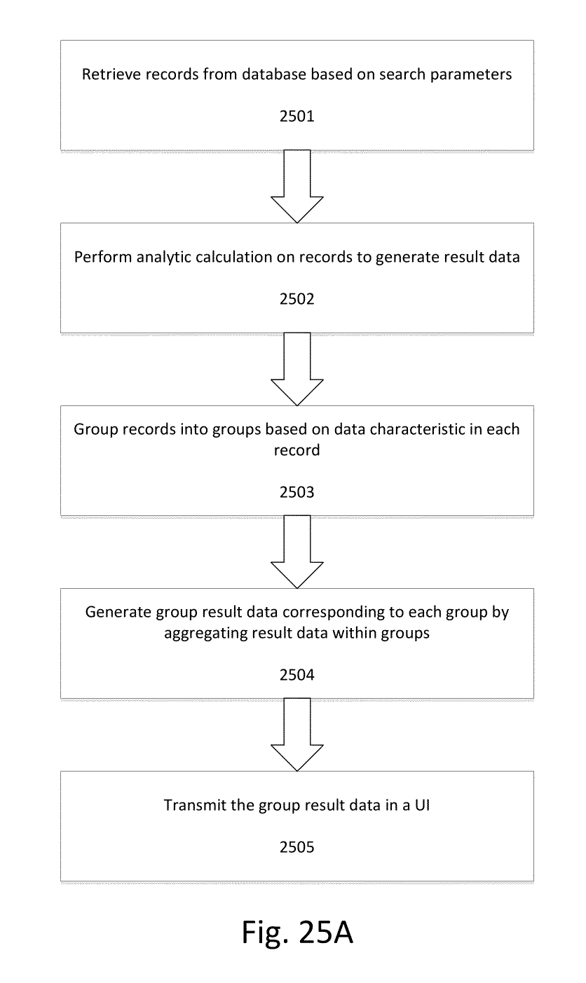

FIG. 24A is a flowchart illustrating another method for transmitting the tenant result data according to an exemplary embodiment. At step 2401 the plurality of unique tenants are divided into one or more categories based at least in part on tenant information associated with each unique tenant. At step 2402 the one or more categories are transmitted in a user interface and at step 2403 a quantity of unique tenants in each of the one or more categories is transmitted in the user interface. Steps 2402 and 2403 can performed at the same time.

FIG. 24B illustrates an example of the method of transmitting tenant result data described with regard to FIG. 24A. In this figure, the plurality of unique tenants have been divided into categories 2411 corresponding to an industry associated with each unique tenant. The industry for each unique tenant can be determined based on an SIC code associated with the tenant identification of the unique tenant. The number of unique tenants 2412 in each category is depicted in the user interface next to the category. Also shown is the average square feet per tenant for each category. For example, the category corresponding to the service industry includes 374 unique tenants with an average of 4,713 square feet per tenant.

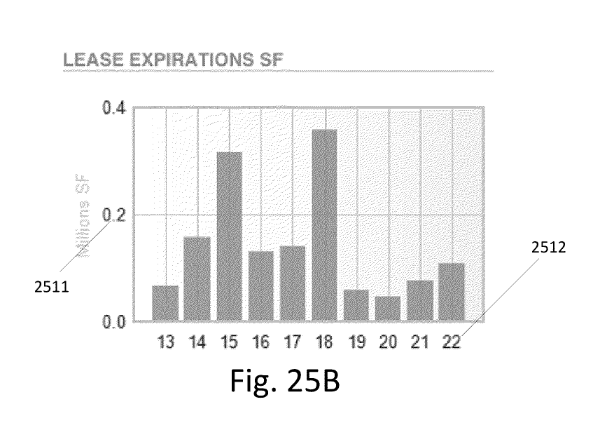

The aggregation of tenant data does not have to be based on the tenant identification and can be based on other tenant characteristics associated with the records in the real estate database. FIG. 25A is a flowchart illustrating a method for aggregating search results based on tenant characteristics. At step 2501 a plurality of records are retrieved from a real estate database based at least in part on one or more search parameters, wherein the each record in the plurality of records corresponds to a unique real estate property and includes a tenant characteristic.

At step 2502 at least one analytic calculation is performed on the plurality of records to generate result data. At step 2503 the plurality of records are grouped into a plurality of groups based at least in part on the tenant characteristic included each record. At step 2504 group result data corresponding to each group in the plurality of groups is generated by aggregating the result data within each group in the plurality of groups.

At step 2505 the group result data is transmitted in a user interface. For example, FIG. 25B illustrates group result data where the tenant characteristic for each record is a lease expiration date. In the figure, the plurality of records have been grouped into a plurality of groups 2512 corresponding to different lease expiration dates, including a group for leases that expire in 2013, a group for leases that expire in 2014, a group for leases that expire in 2015, etc. The result data in this case is the square feet associated with each record and the group result data includes the aggregated square feet for each of the groups. The aggregated square feet for each group is represented as a bar in the bar graph, with the quantity of square feet being indicated on the left side of the graph 2511 in millions of square feet.

Users can also remove records from search results and/or from being counted in the tenant result data and/or group result data. This functionality can be implemented in a similar way to the flagging functionality described earlier. An indication that a user would like to remove at least one record in the plurality of records from the search results can first be received. The at least one record can be removed from the plurality of records. Additionally the user interface can be updated to display updated tenant result data and/or group result data based at least in part on the records remaining in the plurality of records.

The user interface can also be updated dynamically in response to any inputs by the user. For example one or more new search parameters can be received from a user via the user interface or a different real estate type can be selected. A plurality of new records can then be retrieved from the real estate database based at least in part on one or more new search parameters, wherein each new record in the plurality of new records corresponds to a unique real estate property and includes a tenant identification and/or tenant characteristic. The user interface can then be updated to display updated tenant result data and/or group result data based at least in part on the plurality of new records.

The method and system for aggregating search results by tenant transforms the data transmitted in the search results to automatically combine information in records from multiple tenants based on tenant identifications or tenant characteristics. These features improve the performance, and ease-of-use of a computing device that is used to conduct research on a real estate database by automatically aggregating information for tenants who have the same parent company in order to provide a more accurate picture of the real estate in a particular area. Additionally, the tenant based aggregation disclosed herein also improves the performance and efficiency of a computing device used to search for real estate properties by transmitting information that would otherwise be time-intensive to obtain, such as the amount of square feet that will become available each year based on the tenant characteristic of lease expiration dates.

Probability of Leasing

Commercial real estate is an investment vehicle just like stocks or bonds. Investors receive a return on commercial real estate in one of two ways—through the appreciation of the asset, or through the cash flow the asset generates. One of the factors involved in determining both the cash flow and the capital value of an asset is how well leased the building is over time. When space sits vacant in a building the landlord is not collecting rent. To measure how well leased an asset is, investors make assumptions about the amount of “downtime” that exists between when a tenant moves out and when the space is leased to another tenant. The lower the downtime between leases the higher the cash flow will be in the building. And the higher the cash flow of the building the higher the investment value the building will have. So the downtime impacts both types of returns an investor receives on an asset.

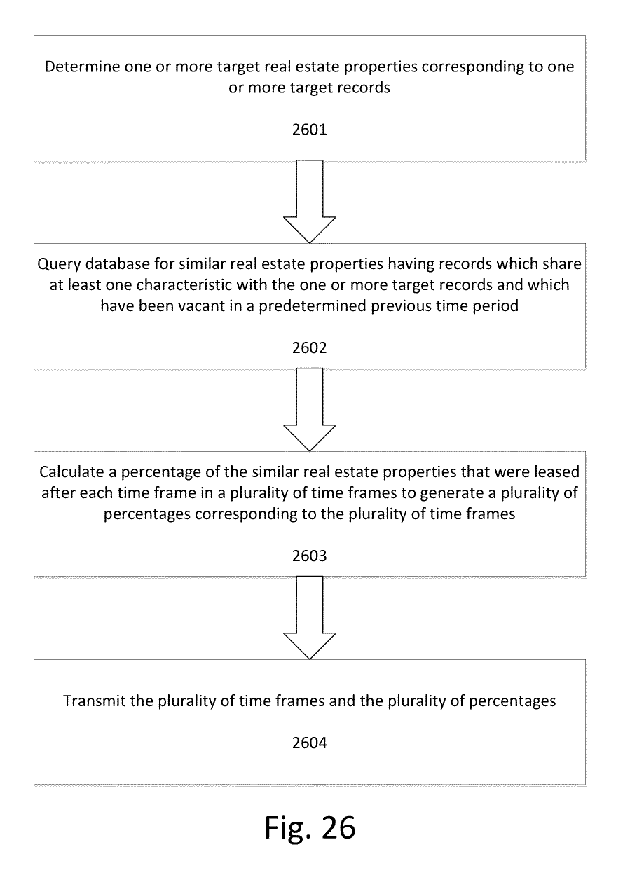

Applicant has developed a novel system and method for quantifying downtime and estimating a probability that real estate property will be leased within a given timeframe. FIG. 26 is a flowchart illustrating the method for estimating a probability of leasing a real estate property.

At step 2601 one or more target real estate properties for which to compute a probability of leasing are determined, the one or more target real estate properties corresponding to one or more target records in a real estate database. The one or more target real estate properties can be determined based on a user selection of one or more real estate properties from a list of real estate properties. The real estate database can store records corresponding to individual suites of space that are available within a building, as well information relating to when a space became vacant/available and when the space became re-leased.

At step 2602 the real estate database is queried for a plurality of records which share at least one characteristic with the one or more target records and which have been vacant in a predetermined previous time period, wherein the plurality of records correspond to a plurality of similar real estate properties. The at least one characteristic can include a building address, a floor, a zip code, a city block, a neighborhood, a particular market, a property management company associated with the real estate property, a characteristic of the real estate property (such as features, bedrooms, bathrooms, parking, etc.), or any other characteristic relating to the real estate property, use of the real estate propery, location of the real estate property, and/or management of the real estate property.

The predetermined previous time period can specified by a user via the user interface, automatically determined by the system, or preset based on a type of property. For example, the predetermined previous time period can be different for an office location than for an industrial location. Optionally, the predetermined previous time period can be omitted and the real estate database can be queried for a plurality of records which share at least one characteristic with the one or more target records and which have ever been vacant.

At step 2603 a percentage of the plurality of similar real estate properties that were leased after each time frame in a plurality of time frames is calculated to generate a plurality of percentages corresponding to the plurality of time frames, wherein each percentage is calculated based at least in part on lease information stored in the plurality of records, including the vacancy date and the re-lease date.

At step 2604 the plurality of time frames and the plurality of percentages are transmitted in a user interface. The information can be transmitted in a variety of formats. For example, the plurality of time frames and the plurality of percentages can be transmitted as a graph with the plurality of time frames forming one axis of the graph and the plurality of percentages forming another axis of the graph.

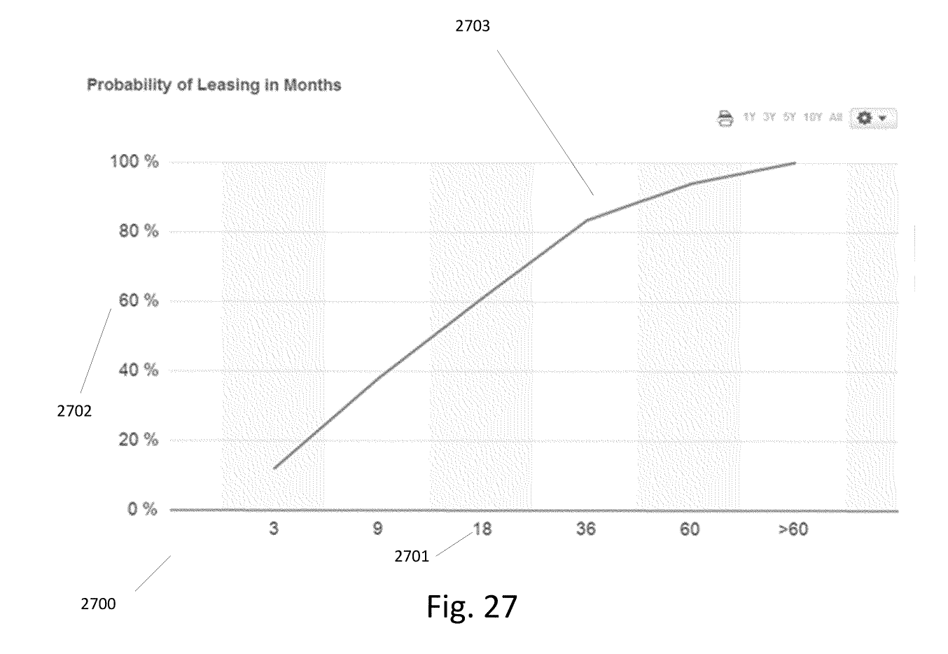

As shown in FIG. 27, the plurality of time frames and the plurality of percentages can provide an estimate of the probability of leasing the target property at different points in time. FIG. 27 illustrates a user interface 2700 showing a graph 2703 of the probabilities 2702 of leasing a particular target real estate property at a predetermined point in time, shown in months 2701. The data in the graph can be comprised of the plurality of time frames and the plurality of percentages determined using the method of FIG. 26.

The method and system for estimating a probability of leasing a real estate property improve the efficiency, performance, and ease-of-use of a computing device that is used to search for real estate properties. As discussed earlier, potential buyers frequently have no way of accurately assessing how long it will take to lease unused space in a particular real estate property which they are considering purchasing. The disclosed method and system leverages data stored in the database regarding vacancies and re-leases to provide an estimate to potential buyers, thereby increasing the amount and quality of information provided to potential buyers of a real estate property. The method and system for estimating a probability of leasing a real estate property transforms data relating to previous vacancies and re-leases of similar properties into data which represents a probability of leasing a target real estate property, thereby improving the performance of a computing device which is used to search for real estate properties by mining data stored in the database to present users with an accurate estimate of downtime.

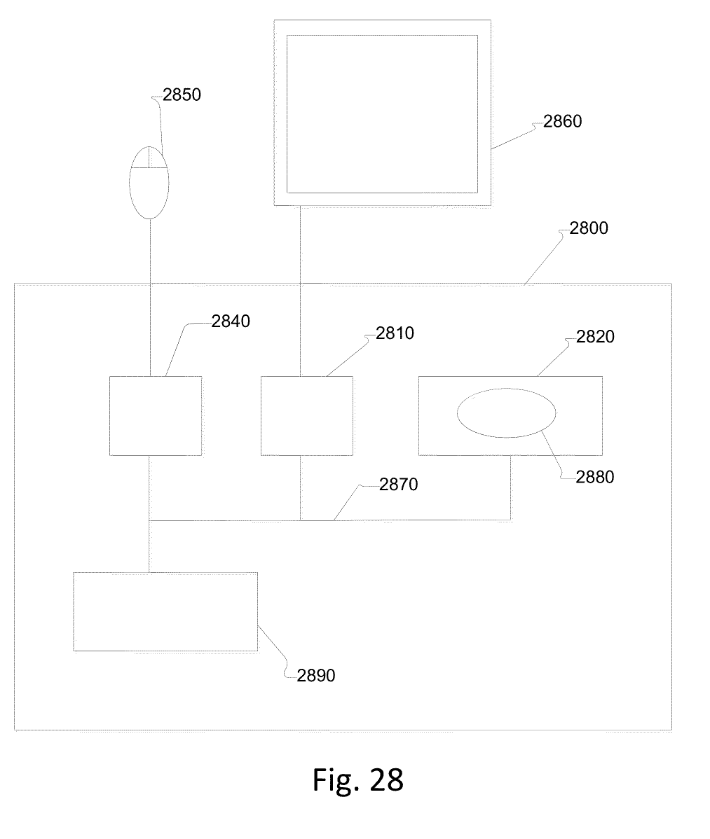

One or more of the above-described techniques can be implemented in or involve one or more computer systems. FIG. 28 illustrates a generalized example of a computing environment 2800. The computing environment 2800 is not intended to suggest any limitation as to scope of use or functionality of a described embodiment.

With reference to FIG. 28, the computing environment 2800 includes at least one processing unit 2810 and memory 2820. The processing unit 2810 executes computer-executable instructions and may be a real or a virtual processor. In a multi-processing system, multiple processing units execute computer-executable instructions to increase processing power. The memory 2820 may be volatile memory (e.g., registers, cache, RAM), non-volatile memory (e.g., ROM, EEPROM, flash memory, etc.), or some combination of the two. The memory 2820 may store software instructions 2880 for implementing the described techniques when executed by one or more processors. Memory 2820 can be one memory device or multiple memory devices.

A computing environment may have additional features. For example, the computing environment 2800 includes storage 2840, one or more input devices 2850, one or more output devices 2860, and one or more communication connections 2890. An interconnection mechanism 2870, such as a bus, controller, or network interconnects the components of the computing environment 2800. Typically, operating system software or firmware (not shown) provides an operating environment for other software executing in the computing environment 2800, and coordinates activities of the components of the computing environment 2800.

The storage 2840 may be removable or non-removable, and includes magnetic disks, magnetic tapes or cassettes, CD-ROMs, CD-RWs, DVDs, or any other medium which can be used to store information and which can be accessed within the computing environment 2800. The storage 2840 may store instructions for the software 2880.

The input device(s) 2850 may be a touch input device such as a keyboard, mouse, pen, trackball, touch screen, or game controller, a voice input device, a scanning device, a digital camera, remote control, or another device that provides input to the computing environment 2800. The output device(s) 2860 may be a display, television, monitor, printer, speaker, or another device that provides output from the computing environment 2800.

The communication connection(s) 2890 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 2800, computer-readable media include memory 2820, storage 2840, communication media, and combinations of any of the above.

Of course, FIG. 28 illustrates computing environment 2800, display device 2860, and input device 2850 as separate devices for ease of identification only. Computing environment 2800, display device 2860, and input device 2850 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 2800 may be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the disclosure and equivalents thereto.

What is claimed is:

1. A method executed by one or more computing devices for dynamically updating search parameters for a real estate database, the real estate database including records corresponding to real estate properties, the method comprising:
transmitting, by at least one of the one or more computing devices, a user interface including a plurality of indicators corresponding to a plurality of real estate uses and one or more search parameters;
receiving, by at least one of the one or more computing devices, a selection of a real estate use in the plurality of real estate uses through the selection of an indicator in the plurality of indicators;
determining, by at least one of the one or more computing devices, one or more use-specific search parameters corresponding to the selected real estate use, wherein the one or more use-specific search parameters are determined by querying a data structure storing a mapping of the plurality of real estate uses to a plurality of use-specific search parameters; and
updating, by at least one of the one or more computing devices, the user interface to include the one or more use-specific search parameters in addition to the one or more search parameters.

2. The method of claim 1, wherein updating comprises revising a layout of the user interface to include the one or more use-specific search parameters.

3. The method of claim 1, wherein updating comprises:
identifying a use-specific user interface corresponding to the selected real estate use; and
transmitting the use-specific user interface in place of the user interface.

4. The method of claim 1, further comprising:
receiving, by at least one of the one or more computing devices, parameter values for at least one of the one or more search parameters or the one or more use-specific search parameters; and
retrieving, by at least one of the one or more computing devices, one or more records in the real estate database based on the parameter values.

5. The method of claim 1, wherein the selected real estate use comprises an office use or a medical use and the one or more use-specific search parameters comprise one or more of floors and rental term.

6. The method of claim 1, wherein the selected real estate use comprises an industrial use or a flex use and the one or more use-specific search parameters comprise one or more of loading docks and ceiling height.

7. The method of claim 1, wherein the selected real estate use comprises a retail use and the one or more use-specific search parameters comprise one or more of frontage and parking spaces

8. A method executed by one or more computing devices for removing search results from a search of a real estate database, the real estate database including records corresponding to real estate properties, the method comprising:
receiving, by at least one of the one or more computing devices, at least one search parameter from a user;
retrieving, by at least one of the one or more computing devices, one or more records from the real estate database based at least in part on the at least one search parameter;
transmitting, by at least one of the one or more computing devices, the one or more records to the user;
receiving, by at least one of the one or more computing devices, an indication that the user would like to remove at least one record in the one or more records from future search results; and
flagging, by at least one of the one or more computing devices, the at least one record for the user, wherein flagged records are configured to be excluded from any results presented in response to queries by that user.

9. The method of claim 8, wherein flagging comprises adding the at least one record to an exclusion list of flagged records associated with an account of the user.

10. The method of claim 8, wherein flagging comprises adding a tag to the at least one record referencing the user and indicating that the at least one record should be excluded from any results presented to the user.

11. The method of claim 8, further comprising:
transmitting, by at least one of the one or more computing devices, a list of flagged records to the user;
receiving, by at least one of the one or more computing devices, an indication that the user would like to include the at least one record in future search results; and
unflagging, by at least one of the one or more computing devices, the at least one record for the user.

12. A method implemented by one or more computing devices for generating a financial model relating to real estate properties, the method comprising:
transmitting, by at least one of the one or more computing devices, a user interface including a data field configured to receive a data value, wherein the data field is associated with a plurality of units of measurement;
receiving, by at least one of the one or more computing devices, a user selection of the data field;
activating, by at least one of the one or more computing devices, a drop-down box in response to receiving the user selection of the data field, wherein the drop-down box is configured to display the plurality of units of measurement;
receiving, by at least one of the one or more computing devices, a selection of a unit of measurement from the plurality of units of measurement displayed in the drop-down box;
receiving, by at least one of the one or more computing devices, a data value entered in the data field, wherein the data value is not the selected unit of measurement;
generating, by at least one of the one or more computing devices, the financial model based at least in part on the data value and the selected unit of measurement.

13. A method executed by one or more computing devices for transmitting multi-dimensional data corresponding to real estate properties, the method comprising:
transmitting, by at least one of the one or more computing devices, a user interface including a two-dimensional matrix of cells corresponding to two dimensions of a mathematical model related to one or more real estate properties, wherein each cell in the matrix corresponds to a two-dimensional location;
receiving, by at least one of the one or more computing devices, a user selection of a cell in the two-dimensional matrix; and
updating, by at least one of the one or more computing devices, the user interface in response to the user selection to include one or more additional cells corresponding to a third dimension of the mathematical model at the two-dimensional location of the selected cell.

14. The method of claim 13, wherein updating comprises:
identifying a first-dimension index value based on the two-dimensional location of the selected cell;
identifying a second-dimension index value based on the two-dimensional location of the selected cell;
selecting an array from a three-dimensional array of the mathematical model by inputting the first-dimension index value as first index value into the three dimensional array and the second-dimension index value as a second index value into the three dimensional array; and
transmitting one or more data values in the selected array as the one or more additional cells corresponding to the third dimension.

15. The method of claim 13, wherein updating comprises:
identifying a first-dimension value based on the two-dimensional location of the selected cell;
identifying a second-dimension value based on the two-dimensional location of the selected cell;
calculating one or more data values in a third dimension based at least in part on the first-dimension value, the second-dimension value, and the mathematical model; and
transmitting the one or more data values in the third dimension as the one or more additional cells corresponding to the third dimension.

16. A method executed by one or more computing devices for providing customized analytics based on search results from a real estate database, the real estate database including records corresponding to real estate properties, the method comprising:
transmitting, by at least one of the one or more computing devices, a user interface including a plurality of indicators corresponding to a plurality of real estate types;
receiving, by at least one of the one or more computing devices, a selection of a real estate type in the plurality of real estate types through the selection of an indicator in the plurality of indicators;
querying, by at least one of the one or more computing devices, the real estate database based at least in part on one or more search parameters and the selected real estate type to retrieve one or more records;
identifying, by at least one of the one or more computing devices, a template corresponding to the selected real estate type, wherein the template is identified by querying a data structure storing a mapping of the plurality of real estate types to a plurality of templates and wherein the template defines one or more type-specific analytic calculations corresponding to the selected real estate type;
updating, by at least one of the one or more computing devices, the user interface to display at least one of the one or more records and display results of the one or more type-specific analytic calculations in accordance with a layout of the template.

17. The method of claim 16, wherein the results of the one or more type-specific analytic calculations are determined by performing the one or more type-specific analytic calculations on the one or more records.

18. The method of claim 16, wherein the results of the one or more type-specific analytic calculations are determined by performing the one or more type-specific analytic calculations on a set of records in the real estate database corresponding to the selected real estate type, wherein the set of records include records that are not responsive to the one or more search parameters.

19. The method of claim 16, further comprising:
receiving one or more new search parameters;
querying, by at least one of the one or more computing devices, the real estate database based at least in part on the one or more new search parameters and the selected real estate type to identify one or more new records; and
updating, by at least one of the one or more computing devices, the user interface to display at least one of the one or more new records and updated results of the one or more type-specific analytic calculations based at least in part on the one or more new records.

20. The method of claim 16, wherein the results of the one or more type-specific analytic calculations comprise one or more of a table, a chart, and a graph.

21. The method of claim 16, wherein the one or more search parameters include a country code.

22. The method of claim 16, further comprising:
receiving, by at least one of the one or more computing devices, an indication that a user would like to remove at least one record in the one or more records from search results;
removing, by at least one of the one or more computing devices, the at least one record from the one or more records; and
updating, by at least one of the one or more computing devices, the user interface to display updated results of the one or more type-specific analytic calculations based at least in part on the records remaining in the one or more records.

23. A method executed by one or more computing devices for providing customized analytics based on search results from a real estate database, the real estate database including records corresponding to real estate properties, the method comprising:
transmitting, by at least one of the one or more computing devices, a user interface including a plurality of indicators corresponding to a plurality of real estate types and a plurality of second indicators corresponding to a plurality of search modes;
receiving, by at least one of the one or more computing devices, a selection of a real estate type in the plurality of real estate types through the selection of an indicator in the plurality of indicators and a selection of a search mode in the plurality of search modes through the selection of a second indicator in the plurality of second indicators;
querying, by at least one of the one or more computing devices, the real estate database based at least in part on one or more received search parameters, the selected real estate type, and the selected search mode to retrieve one or more records;
determining, by at least one of the one or more computing devices, one or more analytic calculations based at least in part on the selected search mode and the selected real estate type; and
updating, by at least one of the one or more computing devices, the user interface to display at least one of the one or more records and display results of the one or more analytic calculations.

24. The method of claim 23, wherein the one or more analytic calculations are determined based at least in part on a country code of a user.

25. The method of claim 23, wherein the results of the one or more analytic calculations are determined by performing the one or more analytic calculations on the one or more records.

26. The method of claim 23, wherein the results of the one or more analytic calculations are determined by performing the one or more analytic calculations on a set of records in the real estate database, wherein the set of records include records that are not responsive to the one or more search parameters.

27. The method of claim 23, further comprising:
receiving, by at least one of the one or more computing devices, an indication that a user would like to remove at least one record in the one or more records from search results;
removing, by at least one of the one or more computing devices, the at least one record from the one or more records; and
updating, by at least one of the one or more computing devices, the user interface to display updated results of the one or more analytic calculations based at least in part on the records remaining in the one or more records.

28. A method implemented by one or more computing devices for aggregating search results by tenant, the method comprising:
retrieving, by at least one of the one or more computing devices, a plurality of records from a real estate database based at least in part on one or more search parameters, wherein the each record in the plurality of records corresponds to a unique real estate property and includes a tenant identification;
performing, by at least one of the one or more computing devices, at least one analytic calculation on the plurality of records to generate result data;
grouping, by at least one of the one or more computing devices, the plurality of records into a plurality of groups based at least in part on the tenant identification included each record and a tenant association data structure which defines one or more associations between a plurality of tenant identifications, wherein each group in the plurality of groups corresponds to a unique tenant in a plurality of unique tenants, and wherein each unique tenant has an associated tenant identification;
generating, by at least one of the one or more computing devices, tenant result data corresponding to each unique tenant in the plurality of unique tenants by aggregating the result data within each group in the plurality of groups; and
transmitting, by at least one of the one or more computing devices, the tenant result data in a user interface.

29. The method of claim 28, wherein the tenant association data structure comprises a tree of tenant identifications and wherein grouping the plurality of records into a plurality of groups comprises, for each record in the plurality of records:
identifying a node in the tree corresponding to the tenant identification of the record;
determining whether the node has a parent node;
grouping the record into a group associated with the parent node based at least in part on a determination that the node has a parent node; and
grouping the record into a group associated with the node based at least in part on a determination that the node does not have a parent node.

30. The method of claim 28, wherein the node has a parent node and wherein grouping the plurality of records into a plurality of groups further comprises:
determining whether the parent node has a grandparent node; and
grouping the record into a group associated with the grandparent node based at least in part on a determination that the parent node has a grandparent node.

31. The method of claim 28, wherein performing at least one analytic calculation on the plurality of records comprises determining a total amount of square feet associated with each record in the plurality of records.

32. The method of claim 28, wherein the plurality of records include lease information and wherein performing at least one analytic calculation on the plurality of records comprises determining a time of lease expiration associated with each record in the plurality of records based at least in part on the lease information.

33. The method of claim 28, wherein transmitting the tenant result data in a user interface comprises:
transmitting one or more tenant identifications corresponding to one or more unique tenants in the plurality of unique tenants; and
transmitting tenant result data corresponding to each unique tenant in the one or more unique tenants.

34. The method of claim 28, wherein transmitting the tenant result data in a user interface comprises:
dividing the plurality of unique tenants into one or more categories based at least in part on the tenant result data corresponding to each unique tenant;
transmitting the one or more categories; and
transmitting a quantity of unique tenants in each of the one or more categories.

35. The method of claim 28, wherein transmitting the tenant result data in a user interface comprises:
dividing the plurality of unique tenants into one or more categories based at least in part on tenant information associated with each unique tenant;
transmitting the one or more categories; and
transmitting a quantity of unique tenants in each of the one or more categories.

36. The method of claim 35, wherein the tenant information comprises information regarding an industry of the unique tenant.

37. The method of claim 28, further comprising:
receiving, by at least one of the one or more computing devices, an indication that a user would like to remove at least one record in the plurality of records from search results;
removing, by at least one of the one or more computing devices, the at least one record from the plurality of records; and
updating, by at least one of the one or more computing devices, the user interface to display updated tenant result data based at least in part on the records remaining in the plurality of records.

38. The method of claim 28, further comprising:
receiving, by at least one of the one or more computing devices, one or more new search parameters;
retrieving, by at least one of the one or more computing devices, a plurality of new records from the real estate database based at least in part on one or more new search parameters, wherein the each new record in the plurality of new records corresponds to a unique real estate property and includes a tenant identification; and
updating, by at least one of the one or more computing devices, the user interface to display updated tenant result data based at least in part on the plurality of new records.

39. A method implemented by one or more computing devices for aggregating search results based on tenant characteristics, the method comprising:
retrieving, by at least one of the one or more computing devices, a plurality of records from a real estate database based at least in part on one or more search parameters, wherein the each record in the plurality of records corresponds to a unique real estate property and includes a tenant characteristic;
performing, by at least one of the one or more computing devices, at least one analytic calculation on the plurality of records to generate result data;
grouping, by at least one of the one or more computing devices, the plurality of records into a plurality of groups based at least in part on the tenant characteristic included each record;
generating, by at least one of the one or more computing devices, group result data corresponding to each group in the plurality of groups by aggregating the result data within each group in the plurality of groups; and
transmitting, by at least one of the one or more computing devices, the group result data in a user interface.

40. The method of claim 39, wherein the tenant characteristic comprises a lease expiration date.

41. A method executed by one or more computing devices for estimating a probability of leasing a real estate property, the method comprising:
determining, by at least one of the one or more computing devices, one or more target real estate properties for which to compute a probability of leasing, the one or more target real estate properties corresponding to one or more target records in a real estate database;
querying, by at least one of the one or more computing devices, the real estate database for a plurality of records which share at least one characteristic with the one or more target records and which have been vacant in a predetermined previous time period, wherein the plurality of records correspond to a plurality of similar real estate properties;
calculating, by at least one of the one or more computing devices, a percentage of the plurality of similar real estate properties that were leased after each time frame in a plurality of time frames to generate a plurality of percentages corresponding to the plurality of time frames, wherein each percentage is calculated based at least in part on lease information stored in the plurality of records; and
transmitting, by at least one of the one or more computing devices, the plurality of time frames and the plurality of percentages in a user interface.

42. The method of claim 41, wherein the plurality of time frames and the plurality of percentages are transmitted as a graph with the plurality of time frames forming one axis of the graph and the plurality of percentages forming another axis of the graph.

43. The method of claim 41, wherein the at least one characteristic comprises a building address.

44. The method of claim 41, wherein the predetermined previous time period is specified by a user via the user interface.

45. The method of claim 41, wherein the one or more target real estate properties are determined based on a user selection of one or more real estate properties from a list of real estate properties.
